(19) United States
(12) Patent Application Publication
(10) Pub. No.: US 2008/0138135 A1
(43) Pub. Date: Jun. 12, 2008

(54) Typability Optimized Ambiguous Keyboards With Reduced Distortion

(76) Inventor: Howard Andrew Gutowitz, New York, NY (US)

Correspondence Address: CARR LLP, 670 FOUNDERS SQUARE, 900 JACKSON STREET, DALLAS, TX, 75202, US

(21) Appl. No.: 11/814,769

(22) PCT Filed: Apr. 26, 2005
(86) PCT No.: PCT/US05/14211

§ 371 Date: Jul. 25, 2007

(30) Foreign Application Priority Data
Jan. 27, 2005 (US) PCT/US2005/003093

(51) Int. Cl. B41J 5/10

(52) U.S. Cl. 400/486

(57) ABSTRACT

An ambiguous keyboard which is sufficiently typable and similar to conventional keyboards to both expert and novice users. The layout of the key involves reduction in the number of keys (5101-4523) and placing several letters on each of the key (5101-4523) to accommodate reduction in size of the keyboard without overly compromising text-entry capacity.

### CROSS REFERENCES

This applications claims priority from PCT application number PCT/US2005/003093 with priority date of Jan. 27, 2005. It incorporates by reference and relies upon: Method and apparatus for accelerated entry of symbols on a reduced keypad PCT/US01/30264 to Gutowitz and Jones, with a priority date Sep. 27, 2001. U.S. Pat. No. 6,885,317 to Gutowitz, with a priority date of Dec. 8, 1998. U.S. Pat. No. 6,219,731, U.S. Pat. No. 6,885,317 to Gutowitz U.S. patent application Ser. Nos. 09/856,863, 10/415,031, and 10/605,157 and all others sharing their priority dates.

### 1 FIELD OF INVENTION

This invention relates generally to computerized text-entry systems based on ambiguous keyboards, more specifically to typability optimized ambiguous keyboards with reduced distortion.

### INTRODUCTION

The first response to change is rejection. In order to improve the usability of a keyboard, its appearance may need to be changed. Yet changing a keyboard from a familiar design makes the keyboard appear at first sight to be less usable. Perception of usability and real usability are at odds. Thus, there is a long-felt but unexpressed need to design keyboards which, despite being novel, are perceived to be usable, thanks to their similarity to products known to be usable. While similar tensions arises in the introduction of many new technologies, this invention teaches solutions to the problem in the particular domain of ambiguous keyboards. Herein disclosed are ambiguous keyboard designs which are novel in that they are of improved typability with respect to a conventional design, yet are of sufficiently minimized distortion with respect to the conventional design that they invite approach and experimentation on the part of naive users.

To minimize distortion, distortion must be appropriately defined, measured and controlled. In the same way, to maximize typability, typability must be appropriate defined, measured, and controlled. To achieve the goals of this invention, new measures of both distortion and typability are introduced. It is shown how to use both these new measures and prior-art measures to synergistically combine distortion minimization with typability maximization. This gives the unexpected result of making devices which appeal to both novice and advanced users.

This invention introduces a novel class of devices which are both of acceptable layout distortion and acceptable typability, where both aspects are important enough to require compromise between the two. Prior-art methods sought to optimize with respect to only one or the other set of constraints, and then, only certain aspects of either layout distortion or typability were considered. Until to Gutowitz U.S. Pat. No. 6,885,317 hereby incorporated by reference and relied upon, and hereinafter Gutowitz '317, there was no suggestion in the literature that layout distortion and typability were related, much less could be simultaneously optimized, as is taught by the present invention.

This invention teaches how to construct devices which synergize the teachings of maximizing typability and minimizing distortion. It is in particular highly non-obvious to measure or minimize distortion, as distortion is a psychological, not physical, property. The initial impression of the device, the promise of usability that the design conveys by its appearance, is at least as important to the commercial success of a device as the actual usability of device when used. Designs which seek to increase typability without limiting distortion do not usually succeed. For example, the Dvorak keyboard (FIG. 3C), did not succeed, despite great fanfare and a claim to improved typability over the dominant qwerty keyboard. This failure may be traced to the fact that Dvorak made no attempt to smooth the rupture between his keyboard and convention.

Since prior art keyboard designers either stick slavishly to convention, or radically alter it, nothing heretofore teaches us to combine typability optimization with distortion limitation, or how to perform this combination. While prior-art designers are focussed either on initial product adoption, or on performance for expert users, for a product to be a real success it has to do both. This invention teaches how to seek commercial success for improved keyboards in a systematic fashion.

Though we are concerned with the appearance of devices, our discoveries are in the realm of engineering, not aesthetics. We seek to engineer perceived comfort and familiarity, not perceived beauty. To achieve these engineering goals, several novel measures introduced which capture the intuitive meaning of “distortion” in the calculation of physical properties of layouts. By means of these measures, a search through the space of alternate layouts can be conducted to find layouts which meet the design constraints.

Up to now, the earliest period to be considered in ambiguous keyboard design is the discovery period (U.S. patent application Ser. No. 10/415,031 by Gutowitz and Jones). During the discovery period, the user does actual manipulation of the device. In the pre-discovery period, the appearance of the device, the period of imagining what it would be like to use the device is essential. The pre-discovery period is a main focus of the present invention.

### DEFINITIONS AND BASIC NOTIONS

This section collects definitions of words and concepts which will be used in the following detailed specification.

Language. Given a set of symbols, one can construct sequences of symbols, and assign probabilities to the sequences. The set of symbols, sequences of symbols, and the probabilities assigned to the sequences will be referred to here as a language. For clarity of discussion, and without limiting the scope of this invention, the languages we will refer to are written natural languages, such as English, and though for concreteness we may refer to symbols as “letters” or “punctuation”, it will be understood by those of ordinary skill in the art that symbols in this discussion may be any discrete unit of writing, including standard symbols such as Chinese ideograms or invented symbols such as the name of the artist formerly known as Prince.

Ambiguous codes. Ambiguous codes are well known in the art. On the standard telephone keypad used in the United States, there are 12 keys, 10 of which encode a digit, and several of these, typically 8, encode in addition 3 or 4 letters of the alphabet, arranged in alphabetic order. These assignments produce an ambiguous code which we will call the standard ambiguous code (SAC). This code is abc def ghi jkl mno pqrs tuv wxyz.

Disambiguation Method. Since several letters are encoded on each key in an ambiguous code, some method of disambiguation must be used to decide which of the several letters is intended by the user. The disambiguation method is typically software which predicts which sequence of letters is intended by the user, based on the user's previous input and a database of linguistic information.

Conventional keyboards. There are essentially three standard keyboards in wide use for Latin alphabets: the qwerty keyboard and its close variants and the 12-key telephone keypad with the standard ambiguous code described above. Other scripts have other keyboards, and it will be appreciated that any device or method described here applies as well to those keyboards for other scripts.

Layouts. A layout is an assignment of letters to keys where the keys are in some spatial arrangement. When no confusion will arise, the words keyboard and layout may be used interchangeably.

Layout distortion. In this disclosure we are concerned with pairs of keyboards: a convention keyboard, and a distorted keyboard which is derived from the convention keyboard by moving some letters from their position in the conventional keyboard. The layout distortion is the difference between the conventional keyboard and the derived keyboard. There are two main classes of layout distortion: order distortion and partition distortion.

Order distortion. The order of a layout is the order in which the labels of keys would be read by a reader of the language whose script is typed by the keyboard, e.g. English is typed with Latin script by the qwerty keyboard, and the keyboard is read left to right, top to bottom, qwertyuiopasdfgh . . . . A order distortion is a displacement of a letter from its conventional position in the order.

Partitions. A partition of an integer n is a set of integers such that the sum of the elements of the set is equal to n. Typically, a given integer admits many partitions, e.g. the integer 5 has the partition 3:2, but also the partition 2:2:1. Algorithms for generating all the partitions of an integer are well known to those skilled in the art. There are various characteristics of partitions which are relevant to this disclosure, some of which are defined immediately below.

Even-as-possible. Most prior art codes use an even-as-possible partition. That is, a partition in which, to the extent possible given the number of keys in relation to the number of letters to be encoded, the number of letters per key is the same. Even-as-possible may be abbreviated as EAP.

Row distortion. Most conventional keyboards comprise keys organized in a regular, typically honeycomb, array with identifiable rows and columns. If a letter is displaced from its conventional row in a new layout, then the new layout has a row distortion. Column distortion is defined in the same way.

Range. The range of a partition is a generalization of even-as-possible property. The irregularity of a partition is defined as the difference between the minimum and maximum number of letters assigned to any key. If the conventional keyboard is an unambiguous keyboard with one letter per key, then, intuitively, the lower the irregularity of the distorted keyboard, the less the keyboard is perceived as distorted.

Dominant class. The dominant class of a partition of letters onto keys is the largest number of keys which the same number of letters. Thus the dominant class of the partition of letters onto keys (4,3,3,1) is the two keys with 3 letters each. Intuitively, the bigger the dominant class in relationship to the total number of keys in the partition, the more the keyboard is regular. Two partitions may have the same range, but have a different number of keys in the dominant class.

Gesture distortion. Layout distortions may be classified as to whether and to what degree the movement of letters from their positions in the conventional keyboard to the distorted keyboard changes the gestures which are used to type the letters. For instance, exchanging the letters q and a on the qwerty keyboard would not affect which finger is used to type either q or a, so the exchange is equi-finger, though it does change the distance the finger must move to type the letter. In both the qwerty keyboard and the distorted keyboard, both q and a are typed with the left little finger by a touch typist.

Typability. Typability refers to the work or time required to enter text. A commonly used measure of work for an ambiguous keyboard is kspc (average keystrokes per character). The amount of time needed to enter text may not be simply related to the kspc. Various processes may have to occur in addition to pressing keys in order to enter text, and these processes take time. For instance, if a word-based disambiguation method is used, and more than one word corresponds to the keystroke sequence used to enter the intended word, then time will be required to examine and select from the possible candidates the intended word.

Drummoll effect. The drummoll effect is a typability constraint relating to the time required to enter text. In general, not all keystrokes take the same amount of time. For instance, if each of a pair of letters in a sequence are typed with different fingers, the sequence may be entered more quickly than if they are typed with the same finger. While a first finger is entering the first letter, the second finger can moved into position to enter the second letter. The first and second keystrokes are thus overlapped in time. This overlapping is called the drummoll effect.

Fitts' Law. Fitts' law is a mathematical model used in typing studies to estimate the time needed to make a keystroke depending on the size of the keys and the distance between keys. The longer the distance, the larger the time, and the larger the keys, the shorter the time.

Steric Hindrance. A term of art borrowed from chemistry. It refers to hindrance between otherwise freely moving objects whose motion becomes hindered when the objects are close to each other, due to the fact that the objects occupy space. Steric hindrance must be taken into account when the size of the keys is small compared to the size of the finger or thumb used to type the key. The steric hindrance effect can modify the results of both drummoll and Fitts' law analyses.

Interaction Mechanism. The interaction mechanism is physical means the user uses to interact with the keyboard. For instance, the telephone keypad is often typed with one finger, or one thumb, or two thumbs. Which interaction mechanism is used may be depend on many factors, depending on the experience of the user and/or other activities the user is engaged in at the time of text entry, e.g. holding a cup of coffee in one hand may prevent a user from using a two-thumb interaction mechanism which she would otherwise prefer. Some typability measures depend on the interaction mechanism, while others do not.

Disambiguation software. When there is more than one letter on a key, some means is needed to select which one is intended by the user at any given time. The selection could be mechanical (e.g. hit the key once for the first letter, twice for the second letter, . . . ) or it could be determined by an algorithm which guesses what is intended depending on context and the statistics of language. Such software is called disambiguation software.

Next function/key. Word-based disambiguation systems use a Next function to allow the user to change the word displayed if the currently displayed word is incorrect, character-based systems use a Next function to allow the user to change the letter displayed if the currently displayed letter is incorrect. These functions will be referred to generically as the Next function, and a key executing the function will be referred to as the Next key.

Typability optimized keyboards with minimized distortion. A keyboard with a given value of distortion is said to be optimized with respect to a typability constraint if it is among the best keyboards with respect to the typability constraint, and has substantially the given value of distortion. For example, take the typability constraint to be lookup error rate, and the distortion measure to be the number of pairwise interchanges to map the distorted keyboard to the qwerty keyboard. If the limit in distortion is 5 pairwise interchanges, then an optimized keyboard with distortion limit 5 is a keyboard with among the best lookup error rates for all keyboards with distortion 5 or less.

### BRIEF DESCRIPTION OF THE DRAWINGS

FIG. 1) The stages of product adoption.

FIG. 2) Summary of some relevant prior art.

FIG. 3) Presentation of Dhiatensor and Dvorak keyboards.

FIG. 4) Presentation of qwerty, azerty, 5-column qwerty, and Cyrillic conventional keyboards.

FIG. 5) Layouts with order-persevering and non-order preserving distortions of Gutowitz '317.

FIG. 6) The half-qwerty keyboard of Matias U.S. Pat. No. 5,288,158.

FIG. 7) Block diagram of a typable device based on an ambiguous keyboard.

FIG. 8) Chart of illustrative typability constraints.

FIG. 9) Touch typability regions and effective key number as defined by Gutowitz '317.

FIG. 10) Illustrative keystroke per character results of the character-based disambiguation of Gutowitz U.S. Pat. No. 6,219,731.

FIG. 11) Chart of illustrative appearance distortion constraints related to partitions.

FIG. 12) Chart of illustrative appearance distortion constraints related to order.

FIG. 13) Illustration of the design of a quantitative distortion measure related to partitions.

FIG. 14) Even-as-possible qwerty-like layouts on various number of columns, following Gutowitz '317.

FIG. 15) Chart of illustrative gesture distortion constraints.

FIG. 16) Flow chart of a method for making a typability optimized keyboard with reduced distortion.

FIG. 17) Summary chart of embodiments illustrating typability and distortion tradeoffs.

FIG. 18) Flowchart of illustrative method of making a practical typability optimized keyboard with reduced distortion for a telephone keypad.

FIG. 19) Effective key number of the best layout found with a given value of layout range and no order distortion.

FIG. 20) The layouts corresponding to the points of FIG. 19.

FIG. 21) Distributions of effective key number as a function of the number of order distortions.

FIG. 22) Summary of results of applying the method of FIG. 18.

FIG. 23) A illustrative best result from applying the method of FIG. 18.

FIG. 24) The results of applying the method of FIG. 18 to a 5-column qwerty-like keyboard.

FIG. 25) 5-column qwerty-like keyboards with a range of order distortion.

FIG. 26) Diagram of an illustrative navigation keypad.

FIG. 27) An alphabetic-order preserving layout for a navigation keypad.

FIG. 28) A qwerty-order and two-thumb gesture preserving layout for a navigation keypad.

FIG. 29) A conceptual distinction layout for a navigation keypad.

FIG. 30) A telephone-keypad-row-preserving layout for a navigation keypad.

FIG. 31) An illustration of steric hindrance due to a large thumb size/key size ratio.

FIG. 32) Application of the drummoll constraint to evaluate two-key layouts.

FIG. 33) An example of drummoll optimization in view of steric hindrance, by means of symbol multiplication.

FIG. 34) A gesture-preserving qwerty-like layout for a steering wheel.

FIG. 35) Typability distribution for keyboards typability optimized simultaneously for two distinct interaction mechanisms.

FIG. 36) Example layouts simultaneously optimized for two interaction mechanisms.

FIG. 37) Flow chart for predictive compensation for distortion.

FIG. 38) A first illustrative example of a chording/ambiguous code for a gaming device.

FIG. 39) A second illustrative example of a chording/ambiguous code for a gaming device.

FIG. 40) Illustrative examples of chording/ambiguous code layouts optimized for typability and minimized for appearance distortion.

FIG. 41) A table illustrating the synergistic effects of partition distortion and order distortion.

FIG. 42) Part of an illustrative example of a family of variable layout keyboards.

FIG. 43) A full-sized member of a family of variable-layout keyboards.

FIG. 44) A comparison of a prior-art data device and a data-device according to the present invention.

FIG. 45) An illustrative example of a keypad for context-based disambiguation.

FIG. 46) An illustrative example of a link/unlink mechanism.

### SUMMARY OF THE DISCLOSURE

The disclosure begins by establishing a framework in terms of the stages of product adoption. It then explains, by means of numerous examples, the meaning of distortion and typability, and shows how to measure these.

A number of non-limiting embodiments are shown as examples to illustrate the scope of the invention. This scope is not limited by the kinds of typability or distortion discussed, and the particular constellation of typability constraints and distortion constraints used in each embodiment are for the sake of illustrating how these heretofore disjoint concepts can be synergistically combined. More than one kind of typability and more than one type of distortion can be combined, and combined as well with other types of distortion and typability not discussed here. The principles revealed operate in a quite general setting, allowing many variations which will be appreciated by one skilled in the art. The non-limited examples discussed here are merely for the sake of illustration, and the true scope of the invention is to be appreciated from the appended claims.

### OBJECTS OF THE INVENTION

It is an object to create ambiguous keyboards optimized for more than one stage of the product adoption process.

It is an object to optimize keyboards relative to typability constraints including but not limited to: lookup error, qwerty error, effective key number, keystrokes per character, drummoll probability, effective drummoll probability, Fitts' law, throughput, robustness, and language generality.

It is an object to optimize keyboards relative to partition-related appearance distortion constraints including but not limited to: even-as-possible, maximum or minimum number of letters per key, range, dominant class, left-right symmetry, up-down symmetry, and monotonicity.

It is an object to optimize keyboards relative to order-related appearance distortion constraints including but limited to: reading order, row-limited reading order, column-limited reading order, exterior-weighting, row-limited letter movement, column-limited letter movement, distance-limited letter movement, number of letter displacements, and number of letter exchanges.

It is an object to relate appearance distortion to quantifiable mathematical models, suitable for use in an optimization method.

It is an object to optimize keyboards relative to gesture distortion constraints including but limited to: same digit, symmetric digit, same hand, nearby digit, and same gesture class.

In is an object to show how to make and use typability optimized ambiguous keyboards with reduced distortion.

It is a further object to present appearance distortion optimized ambiguous keyboards optimized for typability.

It is a further object to present gesture distortion optimized ambiguous keyboards optimized for typability.

It is a further object to present distortion optimized ambiguous keyboards optimized for drummoll effect typability.

It is a further object to present layouts based on a conceptual distinction.

It is an object to present keyboards optimized respecting digit hindrance.

It is a further object to present ambiguous keyboards optimized with respect to more than one typability measure.

It is a further object to present practical solutions to mapping conventional keyboards to the telephone keypad, while optimizing typability and reducing distortion.

It is a further object to present ambiguous keyboards optimized with respect to more than one distortion measure.

It is an object to present ambiguous keyboards with optimized gesture distortion suitable for a gripped object such as a steering wheel or handle bars.

It is a further object to present ambiguous keyboards with optimized gesture distortion suitable for a navigation keypad.

It is a further object to present ambiguous keyboards for a navigation keypad based on alphabetic ordering.

It is a further object to present ambiguous keyboards for a navigation keypad based on alphabetic ordering and row-compatible with a telephone keypad.

It is a further object to present appearance distortion optimized ambiguous keyboards optimized for typability compatible with a keypad which comprises three rows and 1-9 columns.

It is an object to present appearance distortion optimized ambiguous keyboards optimized for typability and compatible with a telephone keypad.

It is an object to present distortion-optimized keyboards with two letter keys.

It is an object to present layout distorted keyboards which are easy to explain and remember.

It is an object to present keyboards which are optimized with respect to more than one interaction mechanism.

Further objects will become apparent through the detailed description of the invention to follow.

### DETAILED DESCRIPTION OF THE INVENTION

### Introduction

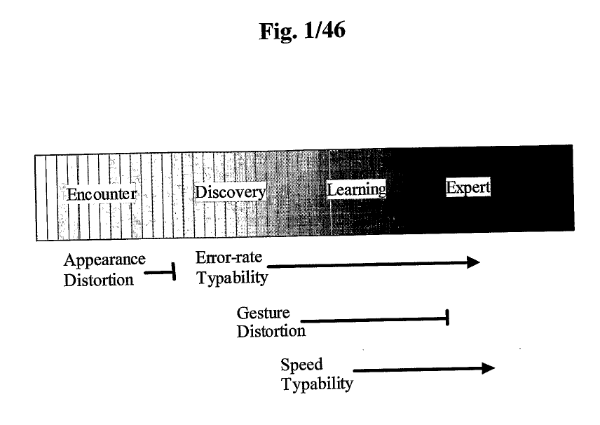

FIG. 1 gives an overview of the invention, showing how the various aspects of the invention relate to the stages of maturity of the product adoption process of the user.

Encounter. In the encounter stage, the user has not yet used the device, but has only seen it, perhaps in a photograph. The only experience the user can have of using the device is his or her mental projection as to what it would be like to use the device. We will call this mental projection the initially perceived usability. The initially perceived usability will be based on actual experiences the user has had with similar devices. One of the discoveries on which this invention is based is that the initially perceived usability can be maximized as the layout distortion from a conventional layout is minimized.

Discovery. In the discovery stage, the user begins to handle the device, and tries to use it to enter text. Research shows that users will typically only make a few initial experiments in entering text before abandoning the device, if these first experiments are not promising, that is, if the device seems hard to use, does not give expected results or otherwise does not “feel right”. It is thus essential that the disambiguation software does not make too many mistakes and otherwise confuse the user in this stage. The number of mistakes the disambiguation software makes is related, in part, to the layout. Given a particular disambiguation method, the layout can be modified to reduce the number of mistakes. One aspect of this invention is to solve the design problem which arises: modifications to the layout to reduce disambiguation mistakes typical reduce initially perceived usability, as they distort the keyboard layout from its conventional form. Thus optimizing for success in the discovery phase may conflict with optimizing for success in the encounter stage.

Learning. In the learning stage, the user who has decided to adopt the device begins to gain mastery, seeking speed and accuracy of text entry though continued practice. Good disambiguation, which first gains importance in the discovery phase, continues to be important. By contrast, initial perceived usability has faded in relevance, as the user now is basing perceptions on actual use of the device. Still, the influence of the conventional design remains, as motor gestures which have been ingrained in the user by long use of the conventional design continue to be active. In the same way that learning to pedal a bicycle leverages already learned motor patterns of walking, any conservation of gesture from the conventional keyboard to the novel keyboard on which it is based will accelerate learning of the novel keyboard. Thus a further aspect of this invention is to provide keyboards which minimally distort gestures used to operate the conventional keyboard, and yet are optimized with respect to the disambiguation mechanism.

Expert. In the expert stage, not only has the initially perceived usability been replaced by actual experience in using the device, conventional gestures have been modified or replaced by gestures adopted to the new keyboard. Users of the new keyboard may develop an interaction mechanism with the device which has little relationship with the conventional interaction mechanism on which it is based. A further aspect of this invention is to perform expert interaction mechanism optimization in a way which is minimally disruptive to optimizations designed to improve user experience at earlier stages of development.

The stages of encounter, discovery, learning, and expert are similar to the stages of romantic involvement, roughly, first sight, flirting, courtship, marriage. The analogy is appropriate in that users may develop very deeply ingrained patterns of interaction with their keyboards, and yet choose which keyboards to become involved with based on criteria which are rather different from those which are critical to success in advanced stages of the relationship.

What will be taught by means of illustrative examples, and claimed in the appended claims, are a set of devices which synergistically combine optimizations directed at more than one level of keyboard adoption. The disclosure seeks to inform the person of average skill in the art to appreciate how to balance optimizations directed at one stage against optimizations directed at another stage, arriving at a keyboard which is both likely to be adopted, and once adopted, will perform effectively.

It should be appreciated that it would be easier to perform such optimizations directed at one stage only. A keyboard could be chosen which is best for each stage. However, learning a keyboard means learning motor reflexes which rapidly input symbols, if the keyboard were to change en route, then these gestures would have to be relearned. Further, typical hardware keyboards do not allow the assignment of letters to keys to be easily rearranged. This invention thus solves a problem which is both difficult and heretofore unfelt.

### PRIOR ART

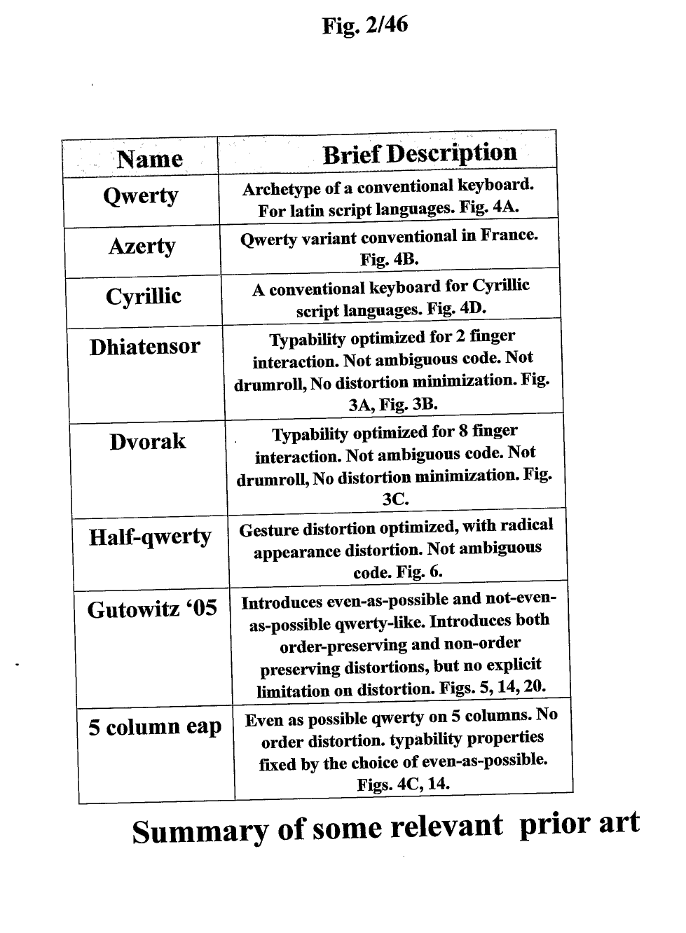

Turning to FIG. 2, we find a chart of selected relevant prior-art keyboards.

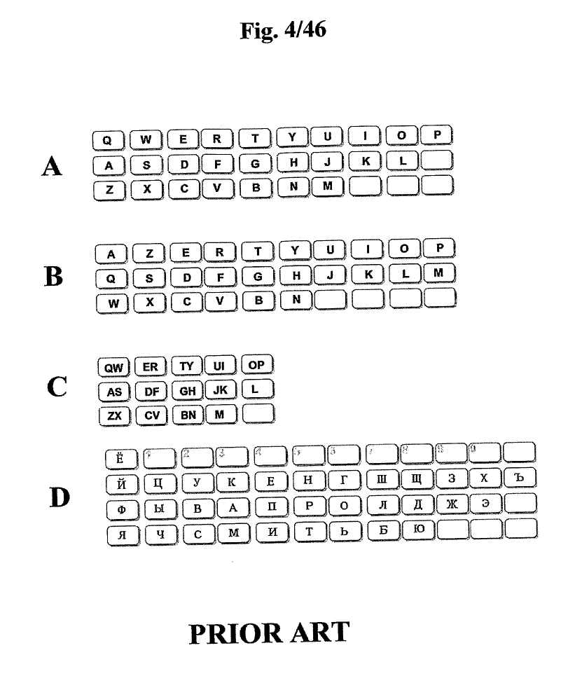

The qwerty keyboard (FIG. 4A) is the archetype of a conventional keyboard layout. It is well-established as a convention in the English-speaking world, and other Latin-script languages typically use a conventional keyboard which is a close variant of qwerty. An example, the azerty keyboard used in France, is shown in FIG. 4B. Though these other keyboards can be considered to be distortions of the qwerty keyboard, they are not ambiguous keyboards and they are not optimized for typability. Other conventional keyboards exist for other scripts, such as the keyboard of FIG. 4D, for the Cyrillic script.

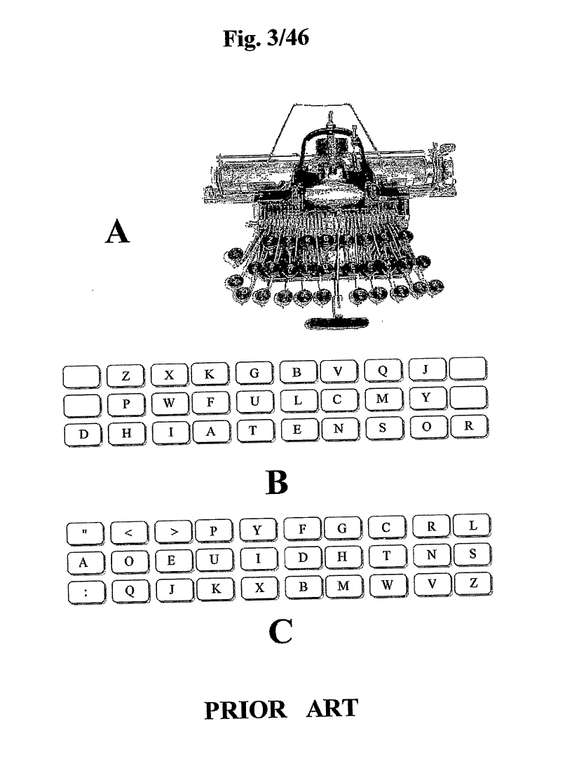

The Dhiatensor keyboard (FIG. 3A and FIG. 3B) is relevant as it is an early example of a keyboard optimized for a two-finger interaction mechanism. The letters are placed in order of probability, from the center outward and from bottom to top row. It is not an ambiguous keyboard, and it not a distortion of a conventional keyboard. Indeed, this keyboard was designed before there were well established conventions for typewriter keyboard layouts.

The Dvorak keyboard (FIG. 3C)), is optimized for an 8-finger interaction mechanism. It seeks to minimize the distance fingers must travel to type the most common letters. It is not an ambiguous keyboard, and it is not distortion minimized. Though qwerty was well-established as a convention at the time of invention of the Dvorak keyboard, Dvorak did not attempt to conserve any part of that convention in his design.

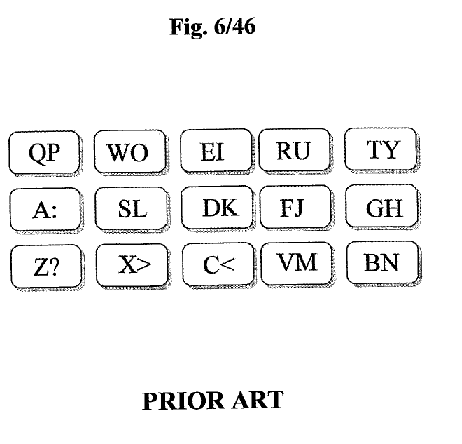

The half-qwerty keyboard of Matias (U.S. Pat. No. 5,288,158) of FIG. 6 is a gesture distortion limited keyboard. It attempts to conserve typing gestures from the qwerty keyboard by “folding” the qwerty keyboard in half, such that letters typed with a given finger on the qwerty keyboard are typed with the same finger (though perhaps of a different hand) on the half-qwerty keyboard. The half-qwerty keyboard is not an ambiguous keyboard, and it is not optimized for typability.

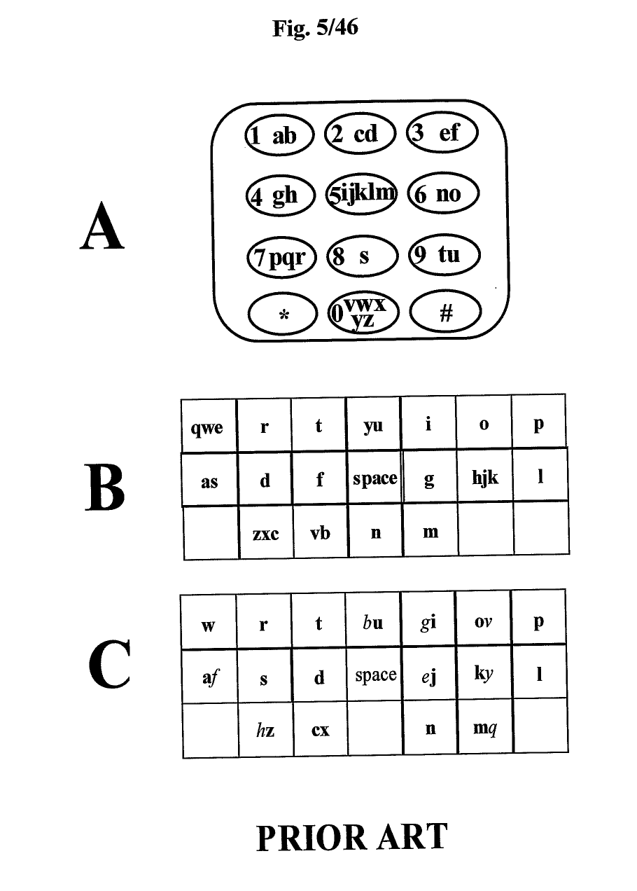

Gutowitz U.S. patent application Ser. No. 09/856,863 herein incorporated by reference and allowed as of the date of this present application will hereinafter be referred to as Gutowitz '317. Gutowitz '317 provides a background for a number of the new inventive concepts presented here. That disclosure introduced qwerty-like partition- and order-distorted keyboards, explored the advantages of even-as-possible and non-even-as-possible layouts, and provided a focus on two-letters-per-key layouts. Some example embodiments from Gutowitz '317 are shown in FIG. 5. FIG. 5A shows a partition-distorted version of a conventional alphabetic layout for a telephone keypad. FIG. 5B shows a qwerty-like layout on 7 columns, with a monotonically decreasing number of letter-assigned keys per row, with partition distortion to optimize typability. FIG. 5C shows a qwerty-like layout on 7 columns with partition and order distortions. The number of order distortions (eight) shown in this figure is quite large compared to the “nearly-qwerty” layouts considered in this disclosure. Nor does this layout obey other order-constraints, such as the keyboard-name constraint, which will be discussed in detail below.

The 5-column qwerty keyboard of FIG. 4C is an even-as-possible qwerty-like keyboard. This layout was used by U.S. Pat. Nos. 5,661,476 and 6,295,052 in a non-ambiguous way. As just mentioned, the use of ambiguous codes for qwerty-like keyboards (including even-as-possible and non-even-as-possible) was pioneered by Gutowitz '317, and used in a commercial setting by Research In Motion, in their model 7100x phones. This even-as-possible layout represents a severe partition constraint and thus leaves an insubstantial margin for a trade-off with typability constraints. As will be discussed below, the 5-column design allows for layouts of much higher typability than the even-as-possible layout of FIG. 4C.

### Even-as-Possible Qwerty-Like Ambiguous Keyboards and Appearance Distortion

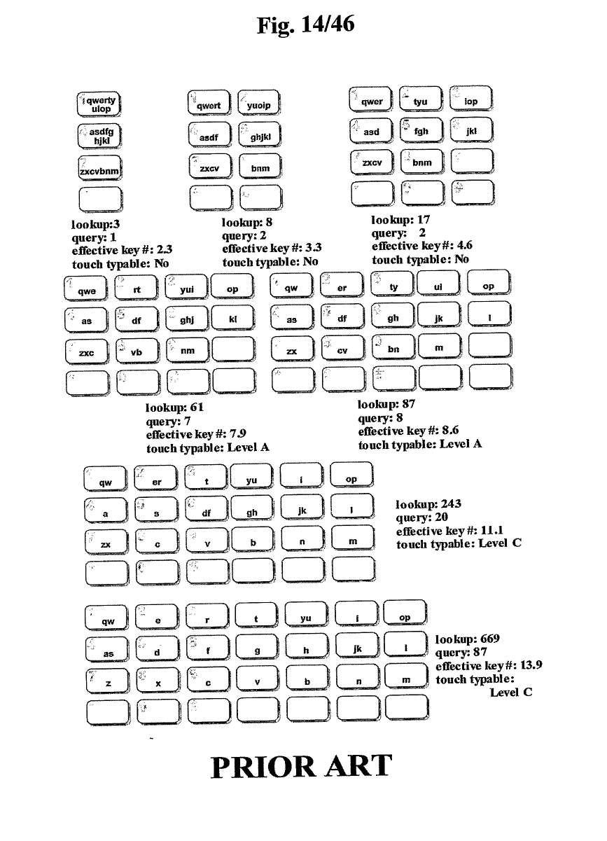

Gutowitz '317 covers both even-as-possible and non-even-as-possible ambiguous keyboards. Even-as-possible is a base from which appearance distortion can be measured. Intuitively, even-as-possible ambiguous keyboards have relatively low appearance distortion since the conventional keyboard on which they are based is trivially even-as-possible since each key has exactly one letter. To be qwerty-like, a reduced keyboard should preferably a) have the same letters in each row as qwerty, and b) have a monotonically decreasing number of keys with letters, as the row increases from top to bottom. Some sample even-as-possible keyboards with varying number of columns, and monotonic decrease are shown in FIG. 14.

Since there are one or very few even-as-possible layouts for a given number and arrangement of keys, optimization for typability over the set of even-as-possible layouts is trivial. The difficult problem, recognized and then solved by this invention, is to limit distortion at a non-trivial level, and then optimize typability while respecting that limit. As long as the distorted keyboard remains a small perturbation from the conventional keyboard, consumers may be expected to accept the keyboard. The trick is to maximize typability even though the perturbation remains small. As can be seen from FIG. 14, the first even-as-possible layout which achieves even the minimal level of touch typability (Level A touch typability of Gutowitz '317) is the 4 column layout. It would be of significant importance to achieve touch typability with a 3-column keypad, as such keypads are extremely wide-spread. This issue will be returned to below.

### Methods

In this section we will discuss the two major properties with which this invention is concerned: typability and distortion.

### Typability

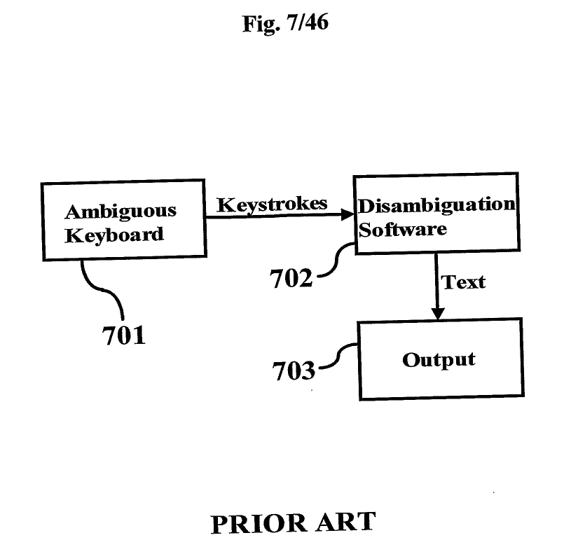

Typability refers to properties which affect the throughput of text when an ambiguous keyboard is used to enter text. How many keystrokes are required per character? How many errors does the system make? How does it respond when a user makes an error? Typability properties have their origin in the interaction of the keyboard with the disambiguation software. To review, a typable device based on an ambiguous code has three main elements. Referring to FIG. 7, we see a block diagram outlining these elements. The ambiguous keyboard 701 sends keystrokes to the disambiguation software 702, which does as well as possible to decode keystroke sequences as text, which it sends to an output 703.

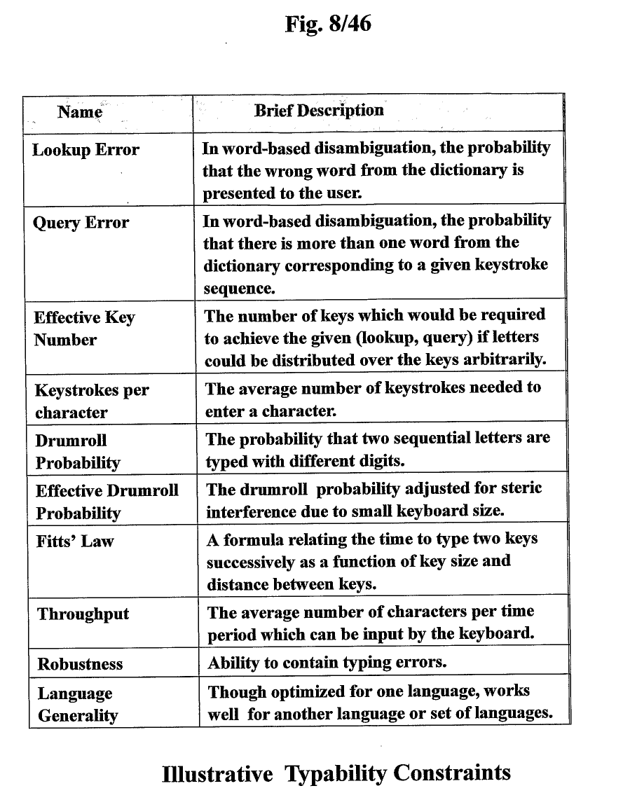

There are many factors which affect throughput of text through the device outlined in FIG. 7. Some of these are listed in the chart of FIG. 8. Some factors are related to the keyboard only, e.g. the difficulty of pressing a key, and some factors are related to the disambiguation system only, such as, in a dictionary-based system, the number of words in the dictionary. We will be often concerned with properties which arise from the interaction of keyboard and disambiguation system, such as lookup error. Lookup error is the rate at which a word-based disambiguation system will guess the wrong word, a word not intended by the user, but which has the same keystroke sequence as the word intended by the user. This property depends both on the disambiguation system and on the keyboard layout.

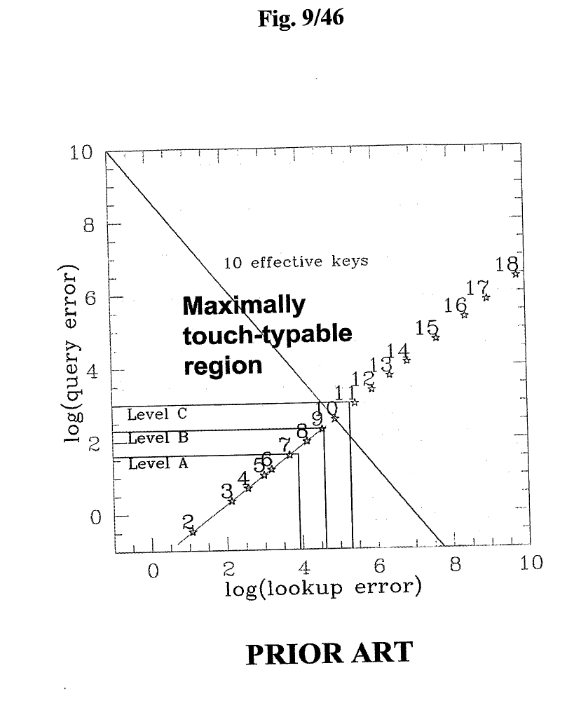

To help appreciate how keyboard layouts relate to typability, we will quickly review character-based and word-based disambiguation methods and measures of their typability. This material is covered in more detail in Gutowitz U.S. Pat. No. 6,219,731, and Gutowitz '317, both hereby incorporated by reference and relied upon. In particular, Gutowitz '317 defines several measures of typability for word-based disambiguation systems, notably lookup error, query error, effective key number, and levels A, B, and C of touch typability. A disambiguation system with an effective key number of n has the same performance as the best that can be achieved on keyboards with n letter keys, if the letters can be arbitrarily assigned to keys to maximize typability. In all of the cases we will consider here, letters cannot be assigned arbitrarily to keys. Indeed, our concern here is with layouts under tight constraints to be as close as possible to a given layout. Thus the effective key number of the layouts we will discuss will be much less than the number of letter keys they possess. The relationship between effective key number and levels A, B, C of touch typability is shown in FIG. 9, taken from Gutowitz '317.

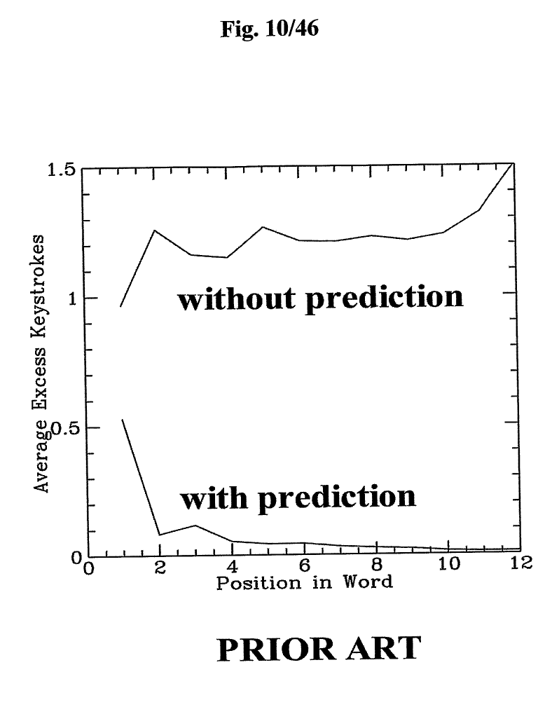

For character-based prediction, a more relevant measure of typability is keystrokes per character. In these systems, the user presses a key, and then a Next key is used to advance the order of letters assigned to the key, in order of likelihood given the previously defined context of other input letters. In Gutowitz '731, the present FIG. 10 was presented, which shows the expected keystrokes per character as a function of the position of a letter in a word. This is done for two systems, the standard non-predictive multi-tap system available on essentially all cell phones, and the predictive character-based disambiguation of Gutowitz '731.

Word-based and character-based disambiguation are but aspects of the more general framework of context-based disambiguation, as discussed in Gutowitz '317. Each sub-type of disambiguation may have a corresponding typability measure which is best applied to it. In particular, and as was pointed out in Gutowitz '731, it is obvious even to one poorly skilled in the art to add word completion or phrase completion to any existing text-entry method without word completion or phrase completion. If word completion or any other feature is added to an existing text-based method, then the quantitative measures described herein also need to be modified to take account of the new feature, a modification which would not escape the scope of this invention.

### 1.0.1 Measuring and Modeling Distortion

Throughout, we will use the qwerty keyboard as an example conventional keyboard. It should be evident that the discussion applies as well to any other conventional keyboard. The conventional qwerty keyboard is characterized as having

1) 1 letter per key 2) monotonically decreasing number of letter-assigned keys as the row varies from top to bottom.

The minimal distortion keyboard will have a distribution of letters over the keys which is as close to this as possible. The maximal distortion keyboard will have a distribution of letters over the keys which is as far from this as possible.

In general, we could consider layouts with different numbers of letter assigned keys in each row. But to simplify the present illustrative discussion, let us make the further restriction that each key in the 3×3 array has at least one letter assigned to it.

The next step is to assign a numerical measure to a quantum of distortion. There are various ways of doing this. To be effective, the measure chosen should be a good model of the perceptual or interactive constraint to be optimized. It will be appreciated by one skilled in the art of mathematical modeling that the model and the phenomenon must be distinguished. In the case of appearance distortion, the phenomenon is psychological: to what degree are the reference conventional keyboard and the distorted keyboard perceived as similar? A person skilled in the art of scientific method would know how to measure this phenomenon in the laboratory, and a person skilled in the art of mathematical modeling would know how to build a mathematical model of the phenomenon. From the mathematical model, the calculations used to perform the distortion minimization called for can be made more rapidly than by direct psychological research. Similarly, scientific observation of human interaction with keyboards, measurements on the anatomy and physiology of the hand, and so on lead a person skilled in the art of scientific method to develop a description of gestures used in typing. Indeed, there is a large body of literature on this subject. From these experiments and literature, a person skilled in the art of mathematically modeling can develop a model of gesture distortion. The models discussed in this disclosure, and the resulting optimized keyboards, are non-limiting examples chosen for their ability to teach the person skilled in the art how to make and use distortion limited and typability optimized keyboards.

To illustrate, we will now consider some variant numerical models of the intuitive “looks as much like the qwerty layout as possible”.

Let us consider two measures:

1) D=distortion the sum over all keys of the number of letters on the key-1.

2) D=distortion the sum over all keys of the number of letters on the key squared.

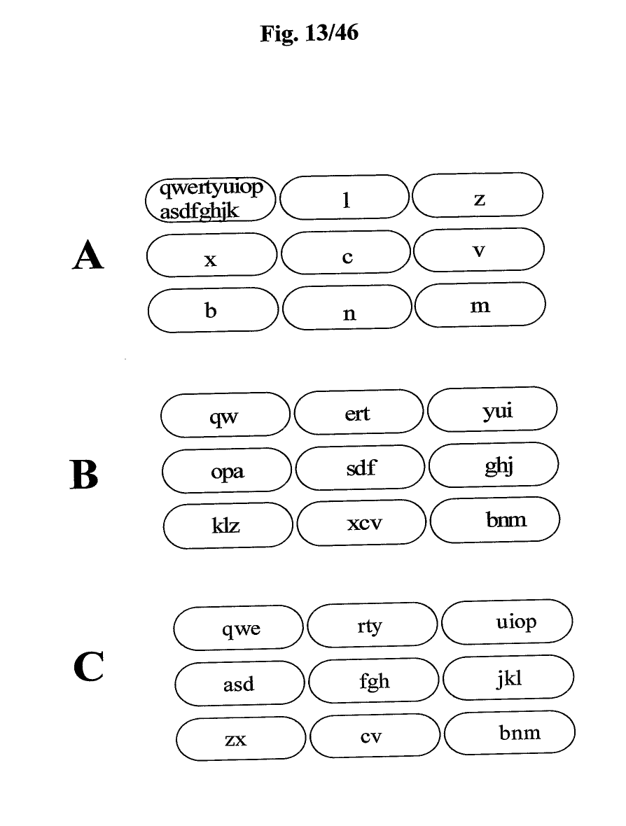

Two extremes are illustrated in FIG. 13. The distortion, D, of the FIG. 13A is 17 according to measure 1) and 18²+8*1=332 according to measure 2). There are 8 other layouts with the same distortion, the layouts with the maximum number of letters on key 2-9, and one letter per key on the others. The other extreme in terms of evenness is shown in FIG. 13B, which has 3 letters per key, except for one key with 2 letters. According to measure 1) FIG. 13B has a distortion of 8*2+1=17, and according to measure 2), the distortion is 8*(3²)+2²=76. In other words, measure 1) does not distinguish between FIGS. 13A and 13B in terms of distortion; each of FIGS. 13A and 13B have the same numerical value of distortion (17). And yet, to most people, FIG. 13B is more qwerty-like than FIG. 13A. This suggests that measure 2) is a more correct representation of the perception of qwerty-likeness than measure 1. Measure 2 gives a lower value of distortion (76) to FIG. 13B than it does to FIG. 13A (332).

By measure 2), FIG. 13C has value 78, greater than the value 76 for FIG. 13B. And yet, FIG. 13B looks less qwerty-like than FIG. 13C. The reason is that in FIG. 13B several letters are not on the same row as they would be in a full qwerty keyboard, whereas in FIG. 13C, they are. This suggests modifying the measure to penalize for letters not in the correct row, e.g.

Σ_{keys}L_{key}²+5*ΣₗₑₜₜₑᵣₛG(l)

where L_{key} is the number of letters on a key, and G(l) is 1 if the letter l is not in the same row as it is in qwerty, and 0 otherwise. This would give us the values 402, 96, and 76 for FIGS. 13A, 13B and 13C respectively. This is a better ranking of these layouts, as it accords better with our perceptions of distortion.

It is to be stressed again that the measure used here is meant as an illustrative example. It has the advantage of being simple and of seeming to correctly order these keyboards by their intuitive perceptual distortion. Any reasonable (in the sense of agreeing with reality) distortion measure could be used in its place.

Psychological testing could be done to determine a functional model which is more in accord with human perception than the simple model considered here. A more accurate model would not change the scope of the invention, only the numerical values assigned to keyboard layouts. In such a psychological test, various layouts would be presented to a large number of subjects a large number of times, and the participants asked to chose from a set of layouts those that they thought were more qwerty-like.

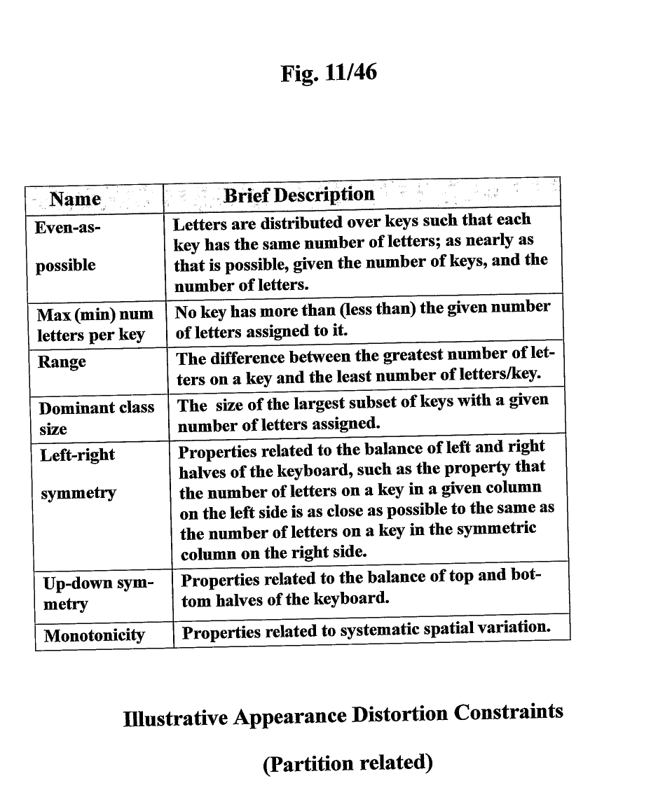

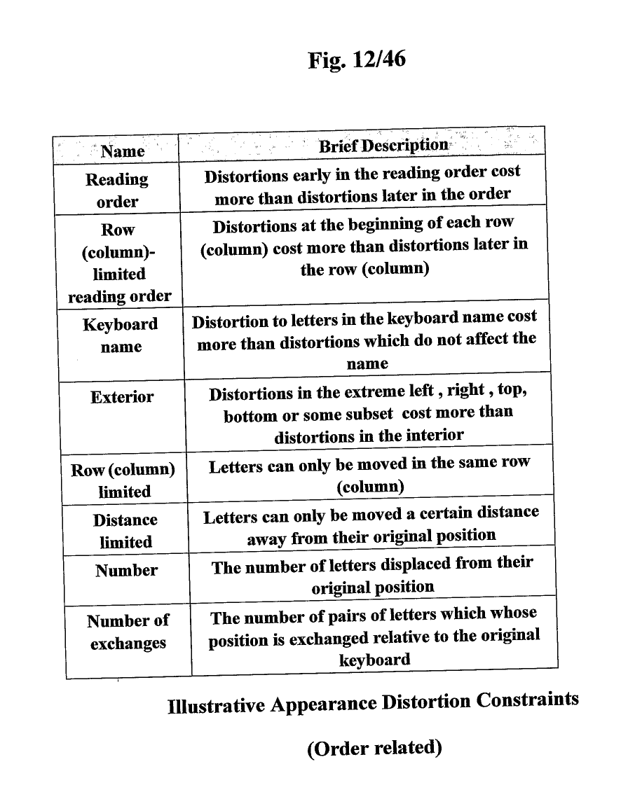

In general, we can distinguish (at least) two classes of layout properties which might be building blocks of a quantitative model of human similarity perception: partition-related properties and order-related properties. Some illustrative partition-related properties are listed in FIG. 11, and some illustrative order-related properties are listed in FIG. 12. The partition properties have to do with the distribution of letters over keys. Whereas the order-related properties relate to where each letter stands in the conventional ordering of letters as expressed in a conventional layout.

We will now more briefly review some exemplary constraints which may be applied using the teachings of this invention to design useful keyboards. In view of this disclosure, it should be evident how to apply these or other constraints to optimize typability while respecting the constraints.

The first set of constraints apply to appearance distortion. The second set of constraints apply to gesture distortion. We will consider various exemplary embodiments displaying combinations of these constraints with various interaction mechanisms and typability measures.

These varied examples are meant to show that any given set of distortion constraints or typability measures can be combined according to the teachings of this invention. These examples are chosen to illuminate various facets of the invention. Under this light, intermediate or hybrid designs should be clearly seen by a person skilled in the art.

### Partition Distortions

Exemplary partition distortions are shown in FIG. 11. These properties are related to the visual balance and harmony of the keyboard. For instance, the range of the partition, the difference between the maximum and minimum number of letters on a key, describes an evenness property. An advantage of partition-related properties is that they are easily measured aspects of a layout. Whether or not the aspect is important to the psychological perception of similarity is a matter for psychological testing. From the standpoint of this invention, what is important is that a person skilled in the art could use these or other quantities as a means to development a mathematical model. The model, in turn, could be used for a basis for sifting through the space of alternate layouts to try to identify those which are best according to the essential factors identified here: typability and distortion. In the illustrative embodiments presented below, we will consider how some of these quantities can be used to produce useful keyboards. Upon contemplation of these illustrations, the person skilled in the art will be able to use other measures, singly or in combination, to select keyboards with good typability and appearance properties.

### Order Distortions

An order distortion is a change in the order in which symbols are read from the keyboard. To define this, we must establish the conventional reading order for the keyboard. Natural written languages generally have a preferred reading order, and the keyboards used to write the language inherit the reading order. English is read from left to right, top to bottom, and the qwerty keyboard is generally read the same way. The name “qwerty” comes from reading the first six letters of the keyboard. A Hebrew keyboard would be read right to left.

There are exceptions. The Dhiatensor keyboard of FIGS. 3A and 3B is read from left to right, bottom row to top row, giving rise to the name “Dhiatensor” (the first letters in the reading order). The “abc” keyboard of the standard ambiguous code, is read left to right, top row to bottom row. A given keyboard may admit multiple readings, as evidenced by multiple names. The dominant convention for the “qwerty” keyboard is left to right, top row to bottom row. However, it was proposed (Neuman, Alfred E. 1964) to read the keyboard right to left, top row to bottom row, resulting in the name “poiuyt”. Were this proposal to become conventional, then, by the teachings of this invention, these letters should be conserved in that order, in addition to or instead of “qwerty”. The half-qwerty keyboard of FIG. 6 can be read both in the qwerty and the Neuman order.

FIG. 12 gives a chart of some illustrative appearance order constraints related to order. Some of these will be used to develop embodiments of the invention below. Each constraint could be a component of a model to quantify perceived distortion. For instance, research suggests that if the first and last letters of a word are correct, but letters in the interior of the word are changed, then people can still read the word with high probability. If the same property holds for reading of conventional keyboards, then a model might give higher weight to changes which occur at the borders of the key layout than changes to the center.

### Gesture Distortion

Gesture distortion is important for those who actually use keyboards, rather than simply look at them. Anyone trained to touch type on qwerty who tries to touch type on a close variant such as the azerty keyboard used in France (FIG. 4B) will be familiar with the effects of gesture distortion. Since some of the letters have been moved from their “correct” position, the gestures used to type those moved letters no longer give correct results. Azerty touch typists experience the same effect when they try to use a qwerty keyboard. The distortion of azerty with respect to qwerty is both an appearance distortion and a gesture distortion. On an ambiguous keyboard, it is possible to distort appearance without distorting gestures. For instance, on the standard telephone keypad, the letters A, B and C are assigned to key 2. Typing any of these letters involves the same gesture: reaching for the 2 key. If the key were to be labeled CBA, with the letters in reverse alphabetic order, then the appearance would be changed, but not the gestures.

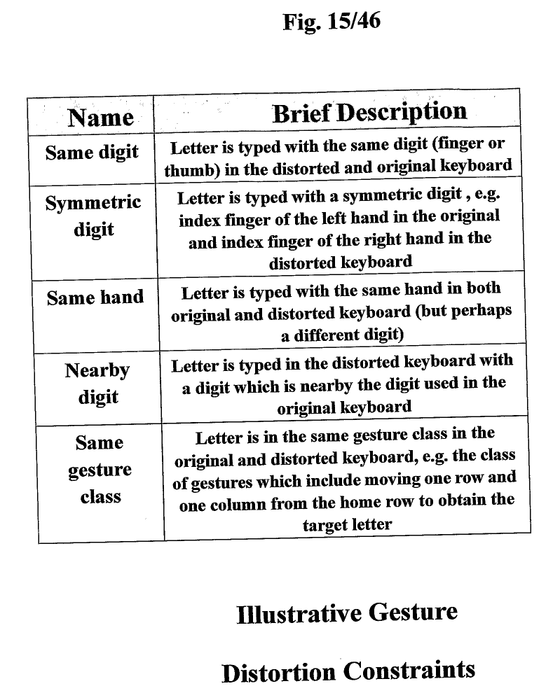

Optimization with respect to gesture must take into account not only the appearance of the keyboard, but the way in which the user interacts with the keyboard. The style of interaction will be referred to as the interaction mechanism. A chart of illustrative gesture distortion constraints is shown in FIG. 15.

### How Much Gesture Distortion is Acceptable?

Azerty is initially somewhat difficult to touch type for a qwerty typist, and yet azerty is initially perceived to be similar enough to qwerty to be used by a qwerty typist. By contrast, everyone recognizes immediately that a Dvorak cannot be touch typed by a qwerty typist without training. This suggests that there is some non-zero threshold of appearance distortion which is permissible without losing the interest of inexperienced consumers. The goal of one aspect of this invention is to use this small margin to introduce improvements in typability. It cannot be over stressed that most commercial failures of prior-art innovations are due to their failure to recognize, let alone obey, this distortion limit.

In the azerty-qwerty distortion, there are 5 letters which are displaced. All of these are changes which involve equi-finger or near-equi-finger movements. Four of the letter movements are be expressed as two swaps. A rule of thumb might be that 5 significant gesture changes are an upper bound for allowed gesture distortion, if the keyboard is to be used immediately without training (possibly with typing errors). Psychological research would be required to give a better bound than this one, gleaned from contemplation of the prior art.

### Symbolic Representation of Distortion

Recall that the problem to be solved by this invention is to minimize the negative impact of distortion on consumer appetite for new keyboard products. A substantial realization is that a distortion may be better assimilated, and thus minimized, if it can be simply symbolically expressed. The simple symbolic expression allows the distortion to be explained, remembered, compensated for, with ease. The simple expression reduces the apparent complexity.

A well-known method in computer science to measure the complexity of an object is the length of the shortest program needed to compute the object. Distortion can be measured in the same way. The description is a set of words sufficient to allow someone knowing those words, along with any conventional knowledge well-known to those skilled in the art, to find each and every letter on the keyboard. Imagine a sales person explaining the new keyboard to a potential customer, e.g. “It's like qwerty, but a and z are reversed” might describe a first keyboard, and “It's like qwerty, but a is moved two keys to the right, r is moved two keys down, t is moved two keys to the left and one key down” might describe a second keyboard. In this case the first keyboard is less distorted than the second, since the first has a shorter description.

Related to description length are other methods to symbolically represent distortions. Mnemonics may be useful, as could be the association of the distortion with a known word, sound, or object. Indeed, any know memorization method might find a role in expressing a distortion in a way which makes it more palatable to a consumer. Several possible symbolic representations of distortion and their use in designing keyboards will be discussed in the detailed description of embodiments of the invention below.

### Method for Making a Typability Optimized Keyboard with Minimized Distortion

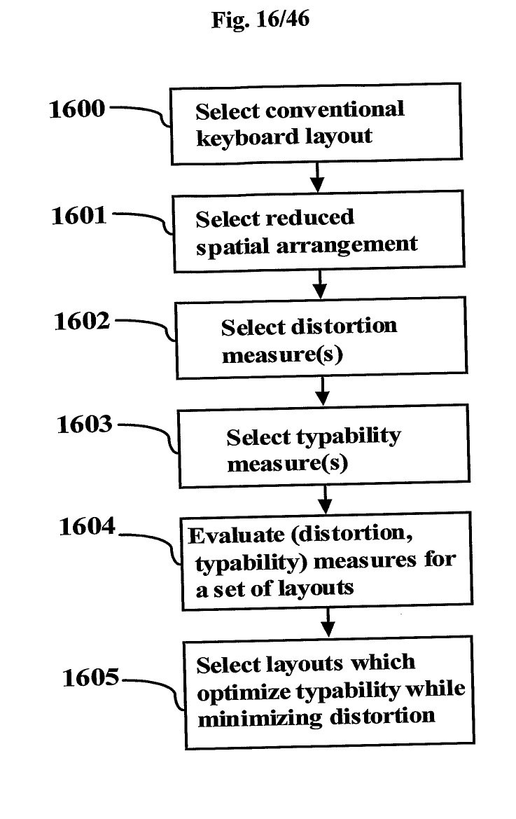

Referring to FIG. 16, a method is described for making a typability optimized keyboard with minimized distortion.

Step 1600: select conventional keyboard layout

Step 1601: select reduced spatial arrangement

Step 1602: select distortion measure(s)

Step 1603: select typability measure(s)

Step 1604: Evaluate the (typability, distortion) measures for a set of layouts

Step 1605: Select layouts which optimize typability while respecting distortion limits

In the set of embodiments below, this method will be carried out in a variety of circumstances, under a variety of design constraints, to illustrate its wide applicability.

### Best Modes

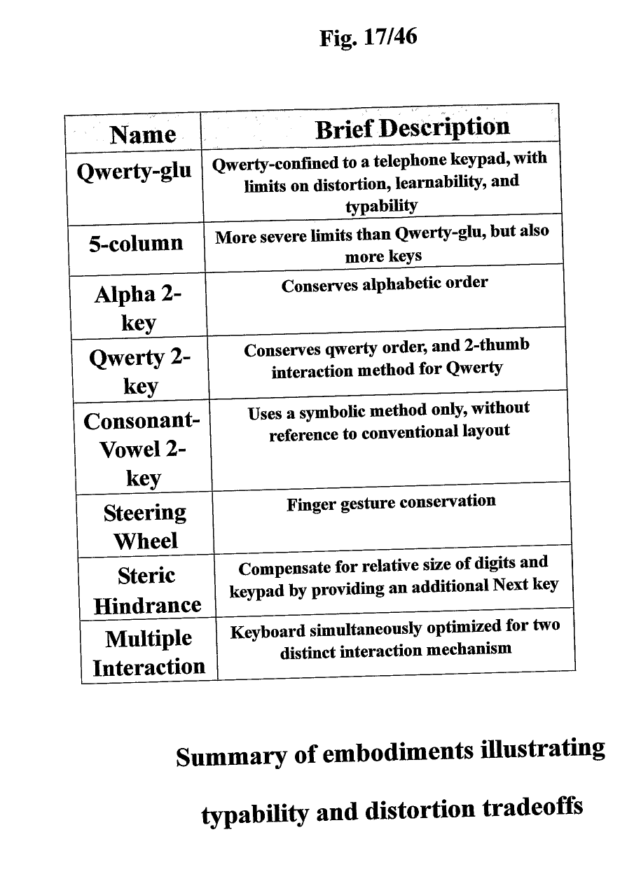

FIG. 17 presents a chart giving an overview of the embodiments to be presented in detail below. Each embodiment is chosen to highlight one or more facets of the present invention, and to thus map out its scope. Upon assimilating the teachings of these embodiments, it will be clear to one skilled in the art how to construct intermediate and hybrid cases, and otherwise depart from the letter of this disclosure without departing from its spirit.

### Practical Qwerty-Like Keyboards for Cellphones

This embodiment is meant as an illustrative example of how the teachings of this embodiment could be applied in a real-life engineering situation, in which several constraints may be simultaneously operative. It will show how various tradeoffs between typability and distortion can be managed to meet industrial specifications.

Here, the desire is for a phone which is typability maximized and appearance distortion minimized. It is agreed to measure appearance distortion in the following way:

1) Only number keys (0-9) of the standard telephone keypad may be used for letters.

2) The reading order of qwerty must be conserved as well as possible, beginning at the left. In particular, the name “qwerty” must be at the beginning of the top row, with all of the letters in order.

3) No more than 4 letters on any key. This constraint is due to practical limitations on the number of letters which can be incorporated in a key label, given the small size of the keys, as well as in the belief that such a partition limitation will reduced apparent distortion.

4) The description of the keyboard in the users manual in English must be as short as possible, and easy to remember. This constraint is adopted both in view of the cost of producing users manuals, and in the belief that it will reduce effective appearance distortion.

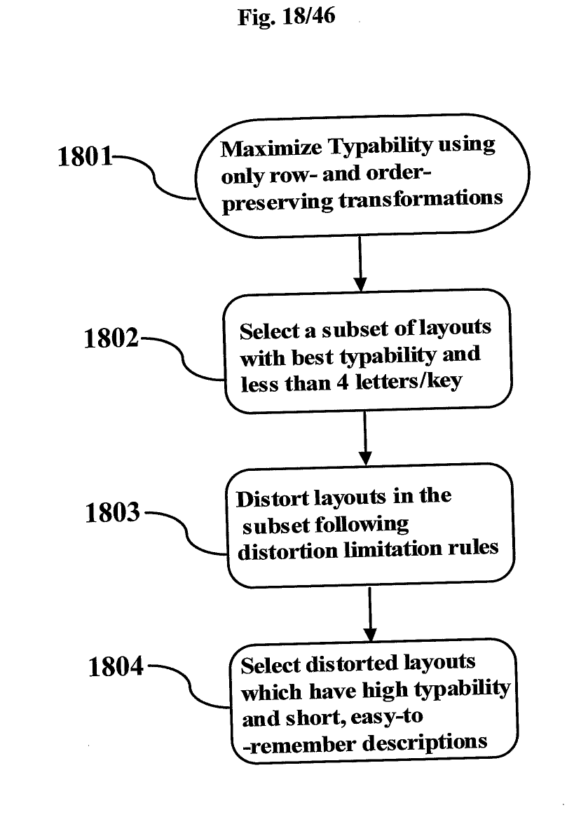

Referring to FIG. 18, we see that one method to find a solution for these requirements is to:

Step 1801: Maximize typability using only row- and order-preserving transformations.

Step 1802: Select a subset of layouts which a) have the best typability, and b) have no more than 4 letters on a key.

Step 1803: Distort each layout from step 1802 in all possible ways by moving 1, 2, . . . , n letters from their original position, placing them on the right of the keyboard, or on the 0 key. To preserve initial reading order, do not move letters to or from the left column of the keyboard, or any of the letters q, w, e, r, t, y.

Step 1804: Select from the layouts of step 1803 those which have a) high typability, b) short, easy-to-remember descriptions.

It will be appreciated that the problem can be approached in other ways, such as using a stochastic optimization technique such as simulated annealing or genetic algorithms. This procedure has the didactic advantage of bringing out the interplay of distortion and typability optimizations, and is easy to execute in practice.

Step 1801: maximize typability using only row- and order-preserving transformations. This can be accomplished e.g. using any of the methods described in Gutowitz '317. Our first goal here is to study the relationship between layout range and typability. For equal typability, lower layout range is preferred. To accomplish this, we will optimize typability (here, measured by effective key number) for each of a set of layouts in which the layout range is fixed at 1 through 7.

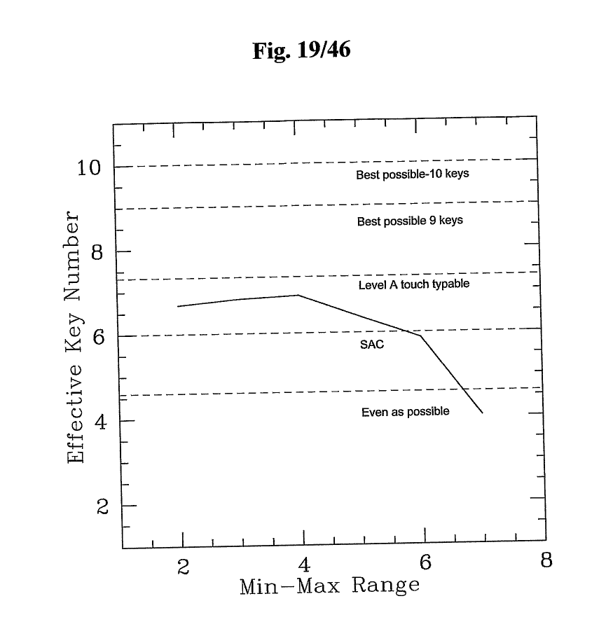

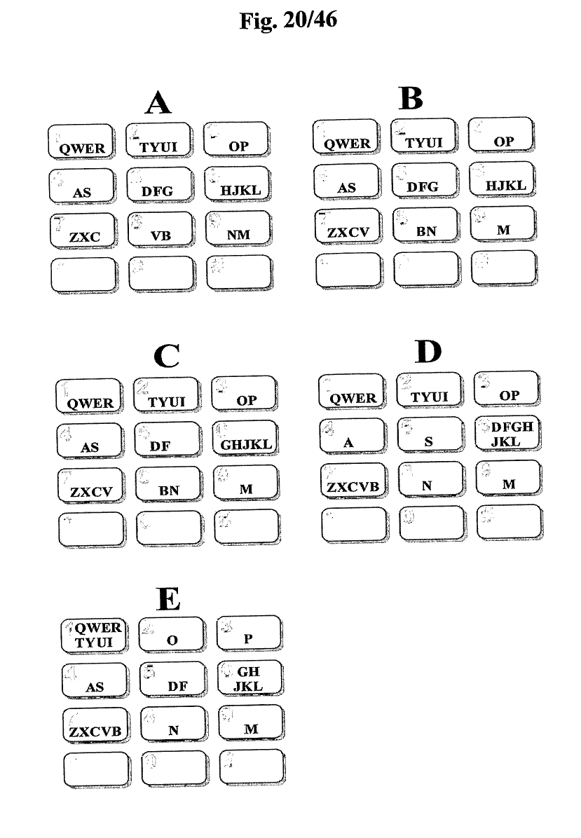

The results of applying this step are shown in FIGS. 19 and 20. In FIG. 19 the effective key number of the best layout found for each min-max range from 2 to 7 is shown as a function of the range. For guidance in interpreting these results, several horizontal lines are drawn. Reading from bottom to top, these lines give:

a) The effective key number of the even-as-possible code qwerty-like code on three columns. The layout of the even-as-possible code is shown in FIG. 14.

b) The effective key number of the Standard Ambiguous Code (SAC), that is, the “abc” code of a conventional telephone keypad.

c) The minimum effective key number for Level A touch typability as defined by Gutowitz '317.

d) The effective key number of the best possible code on 9 keys, allowing an arbitrary assignment of letters to keys.

e) As in d), but for a 10-key code.

The layouts corresponding to the points plotted in FIG. 19 are shown in FIG. 20, where the layouts with range 2-7 are shown in FIGS. 20A to 20E respectively.

We note that these results indicate that there is no advantage in terms of typability to consider ranges above 4. Increasing range not only increases the distortion, but also seems to decrease typability. For further work on this problem, then, we can confine ourselves to the study of layouts with range 4 or less.

Note that the curve of best layouts never passes the line of Level A touch typability. This experiment thus suggests that it is not possible to obtain a touch typable code on the telephone keypad if row and order constraints are completely respected. Still, partition distortion alone is sufficient to substantially increase typability above the base level set by the even-as-possible code.

Step 1802: Select a subset of layouts which a) have the best typability, and b) have no more than 4 letters on a key.

Satisfaction of this requirement emerges from the observation just made that large range reduces typability. In this case, the explicit distortion limitation and a limitation to increase typability are coherent with each other. We will see that in general that is not the case: increase in allowed distortion increases the level of typability which can be achieved.

Step 1803: Distort each layout from step 1802 in all possible ways by moving 1, 2, . . . , n letters from their original position, placing them on the right of the keyboard, or on the 0 key Do not move letters from the left column of the keyboard, or any of the letters q, w, e, r, t, y.

Having done as much as possible with partition distortions, step 1803 explores the effect of adding small amounts of order distortion. The order distortions are limited in the hope of minimizing the perceived distortion.

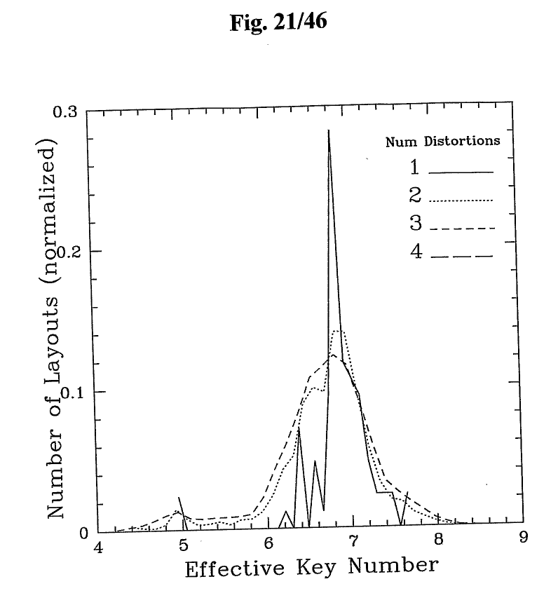

The results of this step are shown in FIG. 21. Here the distribution in effective key number of the layouts generated with 1 through 4 order distortions is shown. It is seen that the distribution of effective key number becomes broader as the number of order distortions increases. Though the average effective key number remains approximately the same as the number of order distortions increases, it becomes possible to find layouts with better and better (and worse and worse) effective key number in the extremes of the distribution.

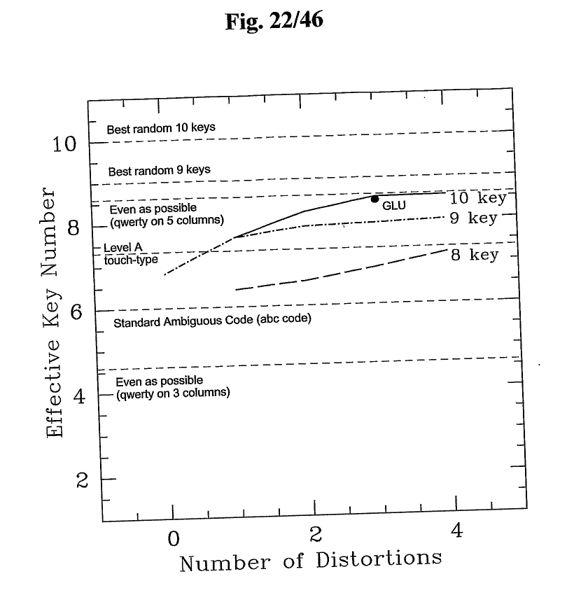

In step 1803 letters were allowed to move onto the 0 key, thus violating both row and order constraints, and potentially increasing the number of letter keys to 10. It also allowed for all of the letters on some key to move to other keys, reducing the total number of letter keys. Thus, FIG. 22 shows three curves, one for each of 8, 9, and 10 letter keys. The effective key number of the best layout for the given number of order distortions and the given number of keys is shown in these curves. The horizontal lines are the same as those of FIG. 19, with the addition of a line giving the effective key number of the even-as-possible code on columns. This even as possible code on 5 columns is shown in FIG. 14.

It is seen in FIG. 22 that with order distortion, it is possible to achieve touch typability of Level A from a telephone key, with 9 or 10 letter keys, though not with 8. Indeed, with 10 letter keys, a level of touch typability substantially the same as the 5-column even-as-possible layout is possible, with as few as three order distortions. But is three order distortions an acceptably low level of appearance distortion? How can the visual impact of these order distortions be muted? This is addressed in the next step of the procedure.

Step 1804 From the layouts of step 1803 select those which have
high typability, and
a short description length,
an easy-to-remember description.

To negotiate this tradeoff, we first attack the constraint of short description length. To quantify this constraint, we will consider layout descriptions of the form: “It has the qwerty layout, except: [itemize exceptions].”

Any distorted qwerty keyboard could be described in this format. The length of the description is related to a) the number of exceptions, and b) the compactness with which the exceptions can be expressed. The typical exception would be written: “except the letter x is on the 0 key”.

Note that if two letters are moved to the same key, then two exceptions can be expressed without doubling the number of words, e.g. “except the letters xy are on the 0 key”.

It would be easier to remember such a rule if the letters were not arbitrary, but pronounceable, or better, spelling a word, such as “lu” or “gum”, e.g. “except ‘gum’ is on the 9 key”. This has the same content as the item “except the letter g is on the 0 key and the letter u is on the 0 key and the letter m is on the 0 key”, but is easier to remember.

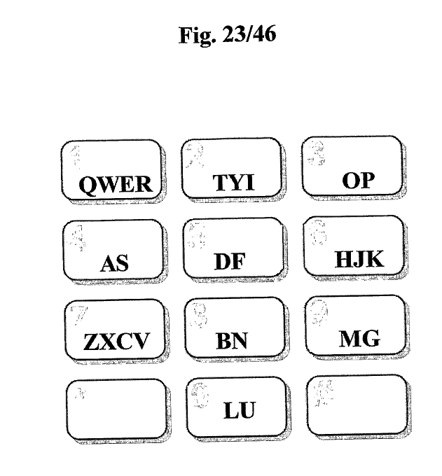

A promising candidate according to these considerations is the “qwerty-glu” layout of FIG. 23, and marked as the point “GLU” in FIG. 22.

This layout has three order distortions. The letters g, l, and u are not in their qwerty positions. They are moved to the end of the layout. The main part of the layout can thus be read without insertions, only deletions, and the deleted letters reappear at the end of the reading order. The letters “glu” are pronounceable, appear in the order in which they are pronounced, and form part of an easy-to-remember mnemonic, “qwerty GLUed onto a cell phone”. The effective key number is very close to the maximum which was achieved in this experiment for any layout with three order distortions.

It should be evident to one skilled in the art that this procedure permits many variations while remaining within the scope of the invention. Different constraints could be used. The steps could be performed in a different order or steps omitted. A different basic convention could be used other than qwerty. A different keyboard geometry could be used, and a different mnemonic employed.

### Application of the Method to 5-Column Qwerty

It should be evident that the method explained above for finding a qwerty-like keyboard of optimized typability and minimized distortion for a telephone keypad can be modified to apply to many situations. In this section we will quickly examine the result of applying the method to building a layout for a 5-column qwerty-like keyboard. While in the case of the telephone keypad, work was needed to find acceptable keyboards with Level A touch typability or better, in the case of 5 columns, Level C and beyond is attainable, using minimal order distortion.

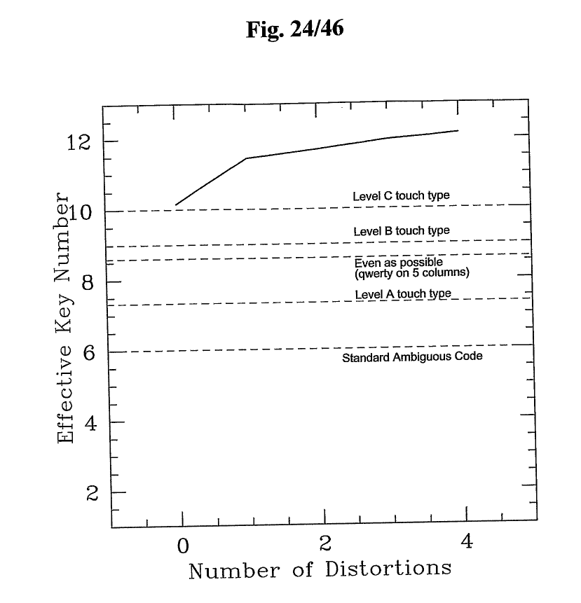

Turning now to FIG. 24, we see the results of applying the method of FIG. 18 to a 5-column qwerty-like keyboard. This figure is essentially the same as FIG. 22, except now applied to 5-column rather than 3-column qwerty-like keyboards. Since the effective key numbers in question are higher, we are able to consider the relationship of these keyboards with higher levels of touch typability, namely levels B and C of Gutowitz '317. While the even-as-possible keyboard on 5 columns has typability between levels A and B, with only partition distortions, and no order distortions, it is possible achieve greater then level C touch typability. As the number of order distortions increases, the level of touch typability increases as well, as can now be expected from the results just presented for 3-column keyboards.

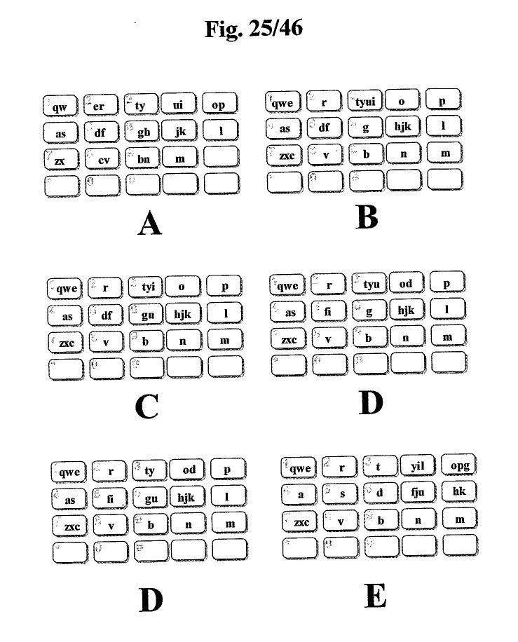

Turning now to FIG. 25, we see details on each of the layouts corresponding to a point on the curve of FIG. 24. For comparison, FIG. 25A shows again the even-as-possible keyboard on 5 columns. FIGS. 25B to 25E show keyboards with increasing amounts of order distortion. The letters displaced are (none), (u), (di), (diu), (lguh) for FIGS. 25B to 25E respectively. It is worthwhile noting that FIG. 25B, with no order distortion, might be perceived as more appearance distorted that FIG. 25C, which has one order distortion. FIG. 25B has a greater range, as the largest number of letters on a key is 4 and the smallest is 1, giving a range of 3, whereas in FIG. 25C, the largest number is 3 and the smallest is 1, giving a range of 2. It may be therefore, that psychological testing would show FIG. 25C to be less distorted than FIG. 25B. In the case of FIG. 25C, a simple mnemonic is available to aid in remembering the distorted layout, “yoU to the center”.

### A Simple-to-Remember Two-Key Keyboard

Perhaps the simplest-to-remember keyboard is one in which all letters are on the same key. In some sense, it is compatible with any convention, and the association of letters to keys is trivial to remember. Unfortunately, one-key keyboards have rather poor typability properties, regardless of how these properties are defined.

The next step toward a full keyboard is a two-key keyboard. At this step already, there are challenging problems for designing keyboards which are both easy-to-remember, compatible with convention, and have good typability properties. This invention shows how to overcome these challenges. The two-key problem has important industrial applications. Many electronic devices which could benefit from text entry do not have a keyboard with even as many keys as a telephone keypad. A typical example is a digital camera, comprising a navigation keypad. Such a keypad typically has two or more arrow keys. These could be used for text entry, if only a sufficiently accurate, sufficiently learnable method were available for such a small number of keys. Text entry would be useful, e.g., to annotate the photographs.

We will now present several embodiments of the invention which solve the two-key problem, in a way which serves to amplify and enforce the teachings already disclosed.

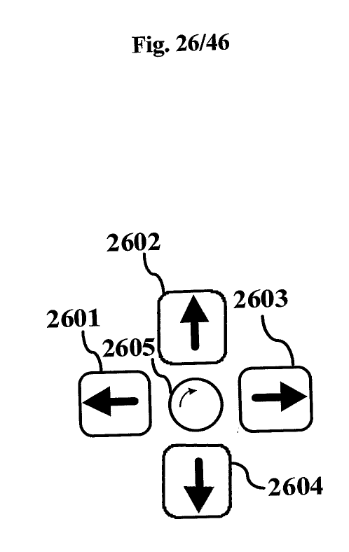

FIG. 26 non-limitatively illustrates a typical navigation keypad. Here there are four arrow keys, are typically associate with movement left 2601, up 2602, right 2603 and down 2604. The center key 2605, is typically associated with the actions “accept” or “advance”.

We will consider several approaches to using such a navigation keypad to enter text, all rather different from each other, yet all within the scope of this invention. These are:
Conservation of alphabetic order.
Conservation of qwerty gestures.
Use of a purely symbolic method, independent of any layout convention.
Row conservation from the telephone keypad.

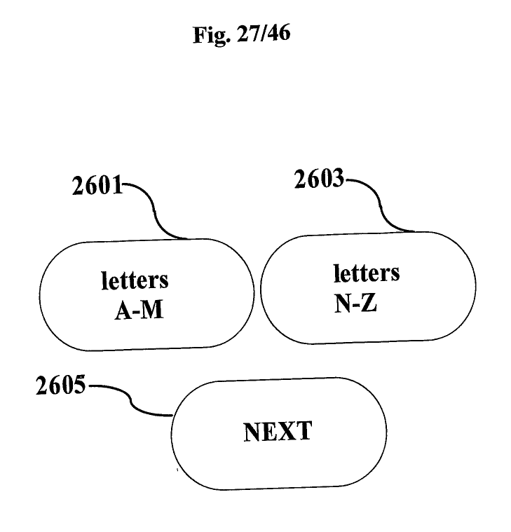

FIG. 27 shows a three-key system with two letter keys, and one Next key. The Next key would be used to advance letters in a character-based disambiguation system, and words in a word-based disambiguation system. In this illustration, the alphabet is split in half, with one half on the letters on each of the letter keys. Other choices are possible, as will be discussed below. A likely association of these three keys with the navigation keypad of FIG. 26 would be to associate the letter keys of FIG. 27 with two of the arrow keys of FIG. 26, and the Next key with either another letter key or the “accept” key.

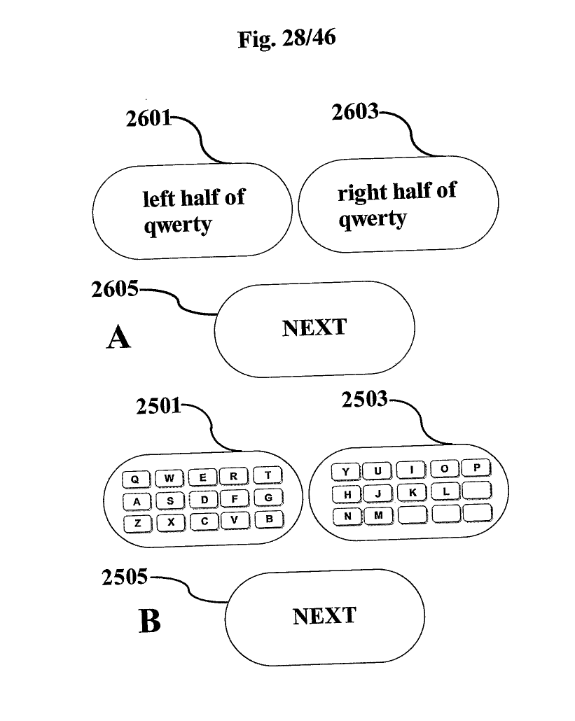

FIG. 28 shows an alternate two-letter arrangement for a navigation keypad in which the letters of the left half of the qwerty keyboard are associated with the left letter key, and the letters of the right half of the qwerty keyboard are associated with the right letter key. FIG. 28A shows the layout conceptually, and FIG. 28B shows the qwerty layout superimposed on the two keys. This keyboard has an advantage for experienced users of reduced qwerty keyboards using a two-thumb interaction method. The gestures of the thumbs are nearly the same, except that in the navigation keypad version, movement of the thumbs between keys is not required.

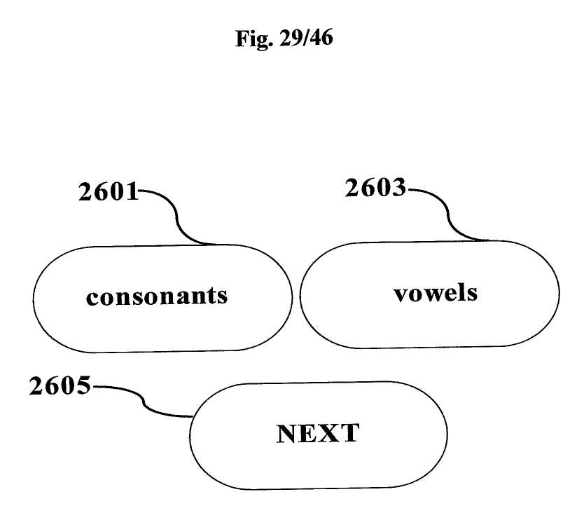

It is possible to design keyboards which optimize with respect to description length, without regards to appearance or gesture distortion. As a non-limiting example, consider the 2-letter-key layout of FIG. 29. In this keyboard, all of the consonants are assigned to the left key, and all of the vowels are on the right key. This last sentence describes the keyboard sufficiently to allow someone who knows the meaning of the words consonant and vowel to locate all of the letters on keys. This keyboard is thus easy to explain and to remember, exemplifying one aspect of the present invention.

We have already pointed to the advantage from the point of view of appearance distortion to minimizing row distortions. Letters in the distorted keyboard should, if possible, be in the same row as the conventional keyboard to which the distortion is related.

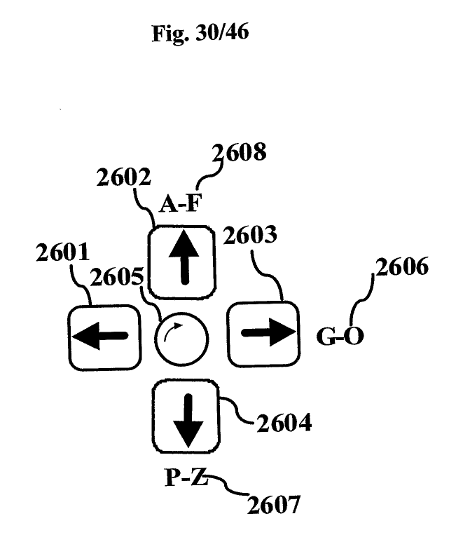

Turning to FIG. 30, we see a navigation keypad in which three arrow keys are used as letter keys. The letters associated to each of the keys are those of a row of the standard telephone keypad. The letters A-F 2608 correspond to (ABC,DEF) on the telephone keypad, G-0 2606 correspond to (GHI,JKL,MNO) on the telephone keypad, and P-Z 2607 correspond to (PQRS,TUV,WXYZ) on the telephone keypad. This keyboard could appeal to those with advanced experience in typing on a telephone keypad. The gestures used to type on the navigation keypad so constructed are similar to the gestures used for typing on the telephone keypad. Due to this careful conservation of the letter-to-row association, the keypad is easy to explain to those familiar with the telephone keypad.

One way by now familiar to readers of this disclosure to evaluate the typability of these various two-key embodiments would be to measure their keystrokes per character, effective key number, or other property related to the disambiguation mechanism. We will consider below the application of some new techniques to this situation.

### A Method to Predict which Two-Key Approach is Better

We have discussed description length as a measure of complexity used in computer science, and shown how it can be applied to measure appearance distortion. Another way that the complexity of an object is conceptualized in computer science is as the running time of the shortest program which computes the object. This complexity measure is also relevant to keyboard design, and could be used to estimate the acceptance by the marketplace of the various two-letter-key embodiments presented above.

The two-letter-key variants of qwerty, alphabetic, and vowel-consonant might seem to be roughly similar in terms of description complexity. One might guess on this basis, that they would all have roughly equal chance of success in the marketplace. To predict this accurately, one need to study how well the complexity measure agrees with the perceptions of actual human buyers. It is perhaps the case that the consonant/vowel keyboard would be judged easier than the split alphabetic keyboard which is in turn easier than split qwerty. Still, those users well trained in two-thumb typing on a miniature qwerty keyboard may prefer split qwerty.

While each of these descriptions correspond to short programs to compute the location of all of the letters, the running time of the program may be quite long. In the case of the split alphabetic keyboard, one may have to imagine reciting the alphabet, stopping at the desired letter, and checking whether they have already recited “m”. This takes a certain amount of time. A person who knows the visual appearance of the qwerty keyboard could mentally scan the keyboard, searching for their letter. A person trained in typing two-thumb qwerty knows the location in the motor patterns of their thumbs. For example, on a 26-letter-key thumb-operated qwerty keyboard the motor pattern to type the letter Q is “move the left thumb to the key with Q, and press the key.” To type on the novel two-key qwerty keyboard, the pattern is edited to “left thumb press the key”. For the two-thumb touch typist, then, the 2-key qwerty keyboard is easy.

### EMBODIMENT

### Illustrative Embodiment of Gesture Conservation with Radical Layout Distortion

The embodiment of this section illustrates that gestures may be conserved even though the layout is radically distorted. The keyboard is meant to be used by drivers while driving, without causing them to remove their hands from the steering wheel. It is meant at the same time to leverage qwerty touch typing ability through conservation of gesture.

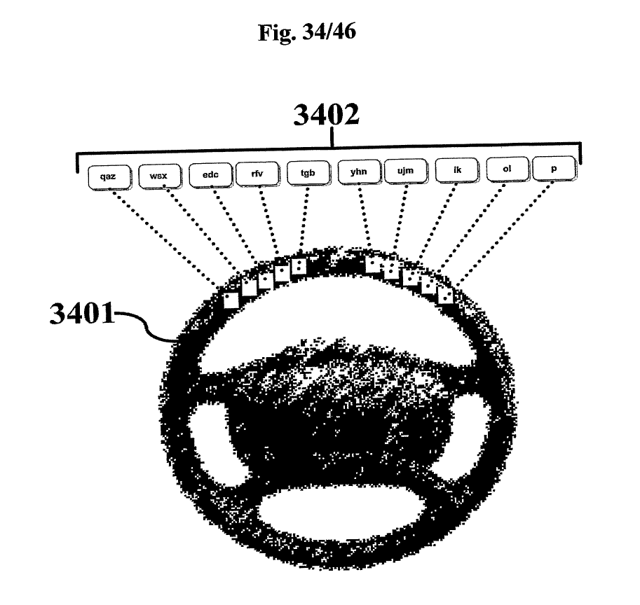

Turning to FIG. 34, we see a steering wheel 3401 into which a keyboard 3402 has been embedded or attached, preferably in a position which is comfortable both for typing and for steering.

To conserve gestures, in particular to make the distorted keyboard be equi-finger with the qwerty keyboard, all of the letters typed with each finger on the qwerty keyboard are assigned to the same key of the distorted keyboard. Thus the letters, q, a, and z, all typed with the little finger of the left hand using the qwerty keyboard, are all assigned to the same key in 3402. Note that all of the letters r, f, v, t, g, b are typed with the same finger of the left hand, but each letters from each column of keys on the qwerty keyboard are assigned to different keys in 3402. This increases gesture compatibility, as the figure must move from its home position to the right to type each of the letters t, g, and b on both the qwerty keyboard and the keyboard 3402. The number of keys could be reduced further by joining these keys, with concomitant increase in gesture distortion and decrease in typability.

If the typability measure is effective key number, then the typability of either of these layouts is rather poor, however, given the teachings of this invention, it will be appreciated that typability could be improved if strict equi-finger or equi-column gesture conservation is relaxed, e.g. by allowing movement of letters to adjacent fingers.

Though this keyboard was discussed in the context of a steering wheel embodiment, it could be useful in any device where the amount of space available for a keypad is limited, permitting only a line of keys. An example might be the edge of a pocket device such as a digital camera or mp3 player. It could be used in the handlebars of a treadmill or bicycle, etc.

### The Drummoll Effect

When asked to press a single key repeatedly as fast as possible, humans typically are able to achieve 7 keystrokes per second. If a letter were entered with every keystroke, this rate would correspond to about 75 words per minute. However, sustained typing rates of 150 words per minute, with bursts up to 212 words per minute have been reported using a regular keyboard. Typing on a regular keyboard requires time to move the fingers from key to key in addition to the time required to press the key. Even ignoring the movement time, these typing speeds are much too fast to be consistent with the repeat time on a single key. Higher speeds can be achieved since while one finger is completing a key press, another finger is beginning another. Keystrokes may occur in parallel, if successive keystrokes are performed by different fingers. This is the so-called drummoll effect. The Qwerty keyboard is widely believed to have been designed such that common pairs of letters are typed with alternating hands, e.g. th, he, qu. We will examine this assertion shortly. Reportedly, this design was meant to minimize jamming of typebars. The maximization of left-right alternation had the (probably unanticipated) advantage for the touch typist of optimizing typing speed. A pair of left-right alternating keystrokes can be performed partially in parallel; the movement of second hand can be planned and executed while the motion of the first hand completes. Even on a single hand, different fingers can move more or less in parallel.

### Selecting a Two-Key Layout on the Basis of the Drummoll Effect

Above we considered description length, and mental computation time as means for predicting which two-key layout consumers would prefer. In this section we will make preference predictions based on the drummoll effect regarding these same keyboard.

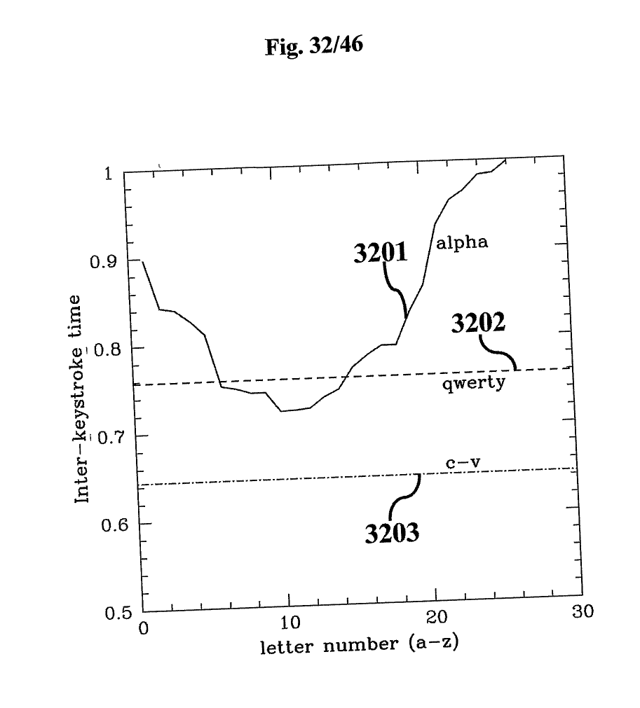

Consider a simple model of the drummoll effect where the time to enter a pair of letters in sequence is 1 if the letters are on the same key, ½ if they are on different keys. Under this model, we can easily predict the time it would take for an expert to enter letters using any of the two-key embodiments discussed above. The results are shown in FIG. 32. In this figure, the inter keystroke time is evaluated for each of 26 alphabetic order variants 3201. In each variant the letters before the given letter on the left key, and the letters after the given letter in order on the right key. The minimum time is for letter number 10 (j). So we have the surprising result that dividing the alphabet at j results in faster times than any other division. A person skilled in the art but uninstructed in the use of the drummoll effect to evaluate keyboards would probably pick a letter more in the middle of the alphabet, such as m (as shown in FIG. 27). As can be seen in FIG. 32, this inter keystroke time is less than that of two-thumb qwerty 3202. As another surprise, the lowest inter keystroke time of all is of the consonant-vowel two-key keyboard 3203. Recall that the argument in favor of using the consonant-vowel keyboard for naive users was that a) unlike the qwerty layout, it does not require advanced experience of two-thumb typing on a reduced qwerty keyboard, and b) unlike the alphabetic keyboard, it does not require mental scanning of the alphabetic order. In this case, then, the criteria of acceptance by naive and experienced users seem to run in the same direction, arguing for deployment of the consonant-vowel keyboard. Psychological testing would be required to confirm or contradict this prediction.

### Optimization of the Drummoll Effect by Minimizing Steric Hindrance

On very small keyboards, ambiguous or not, digits (fingers or thumbs) may share keyboard “territory” with other digits. When the digit size is large compared with the size of keys, then the presence of a digit on a given key may hinder the ability of another digit to occupy keys which are nearby. This effect is called steric hindrance.

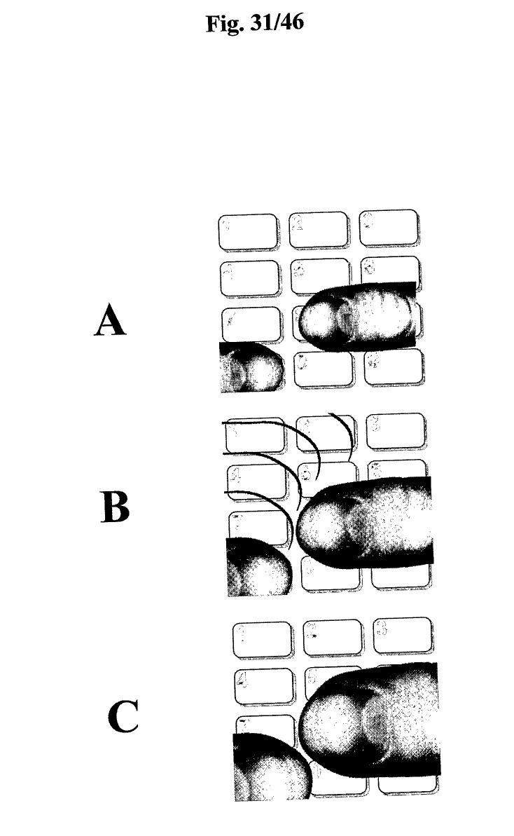

This size effect complicates the analysis of drummoll effects considerably. Referring to FIG. 31, we see a sequence of increasingly small keyboards, capable of being typed with two thumbs. The relative sizes of keyboards and thumbs in this figure are suggestive of the relative sizes in the case of commercial handheld devices. It is seen that the amount of hindrance of one thumb by another depends sensitively on the keyboard size. For the relatively big keyboard, (FIG. 31A), when a first thumb is placed on a key, the second thumb can move to any other key which is not directly covered by the first thumb. At a smaller keyboard size (FIG. 31B), a thumb may hinder not just the key it is currently pressing, but also movement to surrounding keys. As the size becomes still smaller (FIG. 31C), the hindrance may extend to a large fraction of the keypad.

The drummoll effect relies on the ability of one thumb to be moved into position for its keystroke while the other thumb is performing its keystroke. With hindrance, one thumb must wait for the other to be displaced, after making its keystroke, if the target of the second thumb is in the hindered region of the first thumb. The hindrance may be complete or partial, depending on the keyboard size and geometry, and the pair of keys to be pressed in the drummoll.

The exact way in which digits hinder each other with respect to a given keyboard depends on
the interaction mechanism,
the probability distribution of symbol sequences,
the spatially distribution of the keys.

The final design of a keyboard to minimize digit hindrance will depend on how well known these factors are, and how well they are captured in a mathematical model. The present invention teaches the use of some model to measure hindrance.

For non-limiting illustration, we can consider a simple model of this potentially quite complicated situation as follows: Any key directly to the left of, above, or below the target of the left thumb will be considered completely hindered for the right thumb, and, similarly, any key directly to the right of, above, or below the target of the right thumb will be considered hindered with respect to the left thumb. The time for a hindered pair of letters will be considered to be the same as the time for two letters on the same key, and the time for an unhindered pair will be ½ of that time,

tₐᵥₑ=1/(#(i))ΣᵢT(lᵢlᵢ₊₁) where T(lᵢlᵢ₊₁)=rif(lᵢlᵢ₊₁) hindered, r/2 otherwise

and where lᵢ is a letter, #(i) is the number of letters in the string, and r is the time for a double tap on a single letter. This model is inspired by that of MacKenzie, I. S., & Soukoreff, R. W. (2002). A model of two-thumb text entry. Proceedings of Graphics Interface 2002, pp. 117-124. Toronto: Canadian Information Processing Society.

In short, any letter pair where the second letter is on the same or an adjacent key is treated as being effectively on the same key. In this case the double-tap time is used. If two letters are not on adjacent keys, then ½ of the double-tap time is used.

More advanced model would also take account of distance traveled by the fingers, in accord with Fitts, partial hindrance, and other more subtle effects.

### Optimization of Drummoll by Multiplication of Common Symbols

It will be appreciated that the drummoll effect in the presence of steric hindrance can be optimized both by partition and order distortions, following the methods described above, and using a model such as the one presented above. Optimizations can also be made by modifying the physical structure of the keyboard. For example, keys could be spread out or changed in shape to increase the likelihood of a sequential pair of symbols being entered with a drummoll. We will now briefly discuss an embodiment which seeks to optimize the drummoll effect, particularly when steric hindrance effects are important, by multiplying the representation of selected symbols. The , symbol could be a frequent letter, such as the letter e in English, or a frequent punctuation symbol, such as the space symbol, or a frequently used functional symbol such as “Next” or “Shift”.

The positions of the multiplied symbol are chosen such that, given the interaction mechanism, one or another representation of the symbol can often be input in a drummoll sequence, avoiding steric hindrance effects.

For word-based or character-based disambiguation without a shift key, one of the multiplied symbols is preferably “Next”, since the Next function is often needed. When a shift key is used in disambiguation, such as in the embodiment discussed below, the shift key may be chosen to be one of the multiplied symbols.

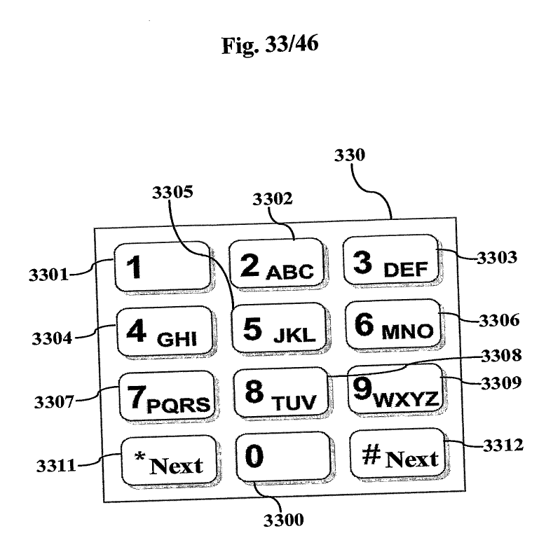

Referring to FIG. 33, we see a telephone keypad 330, with 9 alphanumeric keys 3300-3309, and two Next keys 3311 and 3312. The Next key is multiplied, that is, represented on more than one key.

The Next function is chosen to be multiplied in anticipation that character-based disambiguation will be used. In character-based disambiguation, the Next function can be very commonly used, more often used than any letter or punctuation symbol. In FIG. 33, the keys on which to place the multiplied symbol are chosen in view of a two thumb interaction mechanism. Consider typing the letter “q” in a prior-art system in which there is only one Next key, say on the * key of FIG. 33. “q” is an infrequent letter, and so it is likely that the other letters on the key, p, r, s will be presented by the disambiguation system before “q”, necessitating 3 presses of the Next key to enter “q”. If the keys are small in relationship to the size of the thumb, then the sequence of keystrokes would be:
press the pqrs key with the right thumb.
move the right thumb to the Next key.
press the Next key three times.

According to our model, This sequence will take 4 double-tap time units, plus the time it takes to move the right thumb from the pqrs key to the Next key.

If the keypad were larger, such that the left thumb could be moved to the Next key while the right thumb is on the pqrs key, then the following sequence of keystrokes could be used:
press the pqrs key with the right thumb.
press the Next key with the left thumb.
press the Next key two more times with the left thumb.

The first two steps are combined into a drummoll, since they involve both thumbs so the second step takes ½ of the double-tap time. The total time is 3½ double-tap time units.

On the keypad of FIG. 33, the sequence is:
press the pqrs key with the right thumb.
press the left Next key with the left thumb.
press the right Next key with the right thumb.
press the left Next key with the left thumb.

The time is 2½ double-tap times, even if the keypad is very small. In this way, the multiplication of the Next key essentially eliminates steric hindrance as regards the Next key. It improves the throughput (number of symbols entered per unit time) even on large keypads, and has a more dramatic effect on small keypads.

In general, if only one symbol can be multiplied, given the number of keys available on the device, it should be the most frequently used symbol (functional symbol or otherwise). In the case of the hybrid chording/ambiguous code methods of Gutowitz '317, and the example below, the shift key is generally the best candidate to be multiplied, so that the shift key of the embodiment below could well be represented on both 3311 and 3312. It should be evident that if the number of available keys is sufficient, then the 2nd, 3rd, . . . , nth most frequent symbols could be multiplied as well, and that the position in the layout of these multiplied symbols should be chosen so as to minimize steric hindrance and maximize the drummoll effect.

### Optimization for More than One Interaction Mechanism

The user population is not uniform. At one end there are risk-adverse users who only want something familiar even at the expense of typability, at the other those who value typability and are willing to invest in learning a new interaction mechanism and/or layout to obtain it. Yet, to obtain economies of scale, manufacturers prefer to make large numbers of a single product, and hope to appeal more or less well to everyone in a user population. One approach is to find the least common denominator between the various groups of users. Another approach, the one taken here, is to simultaneously appeal to both the risk adverse and the typability avid. In some other embodiments of this invention, we have sought to make a single keyboard with a single layout which is simultaneously familiar and improved. Another approach to the problem is shown in the present embodiment, in which two keyboard layouts are simultaneously available, with only a change in software between them, and in which both are optimized as well as possible with respect to typability, but with a different interaction mechanism.

More particularly, we consider implementing a shifting and a shiftless layout on the same keyboard. The general method of doing this was discovered by Gutowitz '317, who showed how chording (or other means of combining keystrokes in a single gesture) could be used to optimize typability: in effect creating a new layout from an existing one by adding another shifted “dimension” to the layout. This same approach will be used here, with the distinction that the underlying layout is minimally partition distorted from a conventional layout. While this embodiment is fully within the scope of Gutowitz '317, it has the specific advantage of being minimally partition distorted from a conventional layout, so that both the underlying layout and the shifted layout are optimized for typability. This creates appeal across a broad spectrum of users, including those who refuse to use an unfamiliar shift mechanism, and those who relish that use, given that it provides greatly improved typability.

It will be appreciated that the interaction mechanisms chosen to be combined might be quite varied while remaining within the scope of this embodiment. In particular, 1-digit, 2-thumb, 3-finger, thumb+n-fingers, and 8-finger interaction mechanisms might be combined according to this invention.

To fix ideas, but without the intent of limitation, consider the following set of design specifications:
The layout must be similar to qwerty in appearance.
The layout must fit on a standard telephone keypad.
For those who will not use a shift key, or are not able to since only one hand is available for typing, the keyboard must be typable, and must have typability no worse than the standard ambiguous code, assuming word-based disambiguation.
For those who are able and willing to use a shift key, the typability must be as high as possible.
A single layout must be used for both one finger without shift, and two thumb with shift interaction methods.

In order for the typability to be no worse than the standard ambiguous code, the effective key number must be no less than that of the standard ambiguous code, that is, 6.0. In order to limit appearance distortion, we may attempt to use as a base layout any qwerty-like layout for the telephone keypad with only partition distortions and such that the effective key number is at least 6.0. We may then consider all possible ways of shifting one letter from each of the keys on each of the layouts, and evaluating the effective key number of the shifted keyboard.

For comparison, we may also consider using one of the best telephone keypad layouts with order distortion, the qwerty-glu layout identified above, and again consider all possible ways of choosing one letter from each of the keys to be the shifted letter.

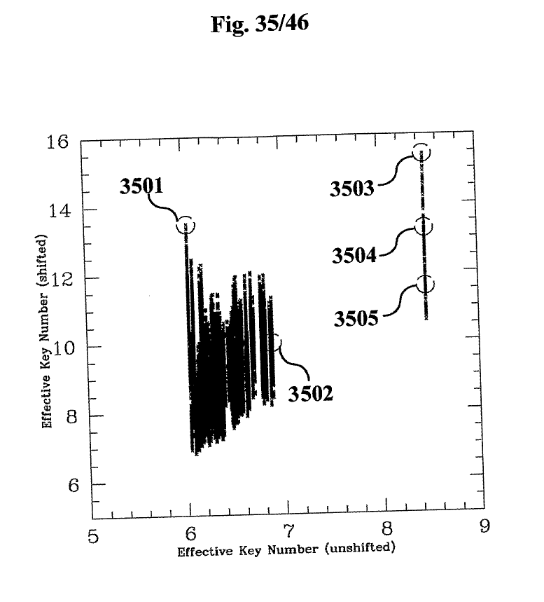

The results are shown in FIG. 35. On the left are shifted layouts derived from the non-order distorted layouts, and on the right, the shifted layouts corresponding to qwerty-glu are shown. Plotted are the effective key number of the base layout vs. the effective key number of each of the corresponding shifted layouts.

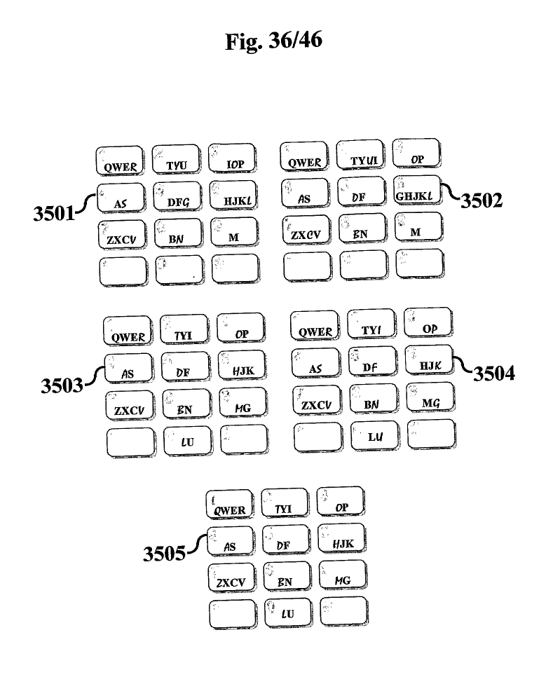

There are many interesting points in this set. The person skilled in the art could, in view of previous embodiments, chose one or the other depending on further design specification. For instance, if the requirement is to favor typability of the shifted layout over typability of the base layout, and to avoid order distortion, then the layout 3501 may be chosen. This layout is more fully shown in FIG. 36. In the full view, the shifted letter on each key is shown in an italic font, whereas the unshifted letters are shown in normal font. Similarly, if the desire is to favor typability of the base layout over typability of the shifted layout, but order distortions are not permitted, then layout 3502 (FIGS. 35 and 36) may be chosen.

If order distortions are permitted, then an improvement in the typability of both the base and the shifted layouts can be obtained, as seen in FIG. 35. There are many shifted layouts corresponding to each base layout. To select a single shifted layout from the set of shifted layouts corresponding to the base layout qwerty-glu, we may consider the economy of description constraint discussed above. The over-all best layout considering only typability is identified as 3503 in FIGS. 35 and 36. We see that for layout 3503 the shifted letter is the last letter on each of the keys 1 and 7, and the first letter on each of the other letter keys. To minimize the description length, one may prefer a layout in which all of the keys have either the first or the last letter as the shifted letter. All keys with the last letter shifted is the layout 3504 of FIGS. 35 and 36, and all keys with the first letter shifted is layout 3505 of FIGS. 35 and 36. Unfortunately, in this case, short description length and typability are at odds. Between last letter on each key shifted and first letter on each key shifted, one may prefer first letter shifted, since capital letters are a) usually the first letter of a word (in English) and obtained by a shift using a standard full-sized keyboard. Thus 3505 would be preferred. However, 3505 has the lowest effective key number of any of 3503, 3504 and 3505. Layout 3504 is intermediate in terms of familiar description, and intermediate in terms of typability. 3503 is excellent in terms of typability, but requires more description. Comparing the shifted layouts of qwerty-glu to the shifted layouts corresponding to non-order-distorted layouts 3501 and 3502 we see that, even though they have order distortion, they have less partition distortion (the range of qwerty-glu is smaller). Thus, one of the shifted relatives of qwerty-glu may in fact be perceived as less appearance distorted than the non-order-distorted layouts. Only psychological testing in which participants are asked to identify the layout they consider to be most qwerty-like could resolve this issue fully.

It will be appreciated that though throughout we have referred to “shifting” as a means to unambiguously identify one letter on each of the letter keys, any other known means could be used, such as double tapping for the shifted letter and single tapping for the unshifted letter, using a long press for one, a short press for the other, etc.

### Predictive Compensation for Distortion

In the learning phase, when the user is making a transition between using the conventional keyboard and the novel, distorted keyboard, typing errors may occur due to mixing of conventional typing gestures with novel typing gestures. The effect is to make an unambiguous keyboard ambiguous, and introduces an additional ambiguity for keyboards which are already ambiguous.

Disambiguation software can be used to resolve many of these ambiguities. For instance, an azerty keyboard is a distortion of the qwerty keyboard for a person trained to type on qwerty. If such a person attempts to type English on an azerty keyboard, they will often type “zhat” since “what” is a frequent word in English, and the letters w and z are reversed in position from qwerty to azerty. Since “zhat” is not a common word in English, disambiguation software could be designed to automatically replace each occurrence of “zhat” with “what”. While the basic idea is simple, practical difficulties arise in many instances. The user may have wished to type “zhat”, perhaps as an abbreviation. In this case, replacing “zhat” with “what” would be an error. It may be difficult for the disambiguation software to determine if “zoo” was typed correctly, or “woo” was meant, since neither is uncommon.

The same considerations apply to character-based disambiguation. For instance, the letter pattern “zz” is much more frequent in English than the pattern “ww”, and yet it would be an error to replace www with zzz in a URL.

Like training wheels, disambiguation software can be an aid in the beginning of learning, and a hindrance later. It is thus desirable for the strength of distortion-compensation disambiguation to be adjustable. This can be accomplished in a variety of ways. The preferred way would be to compute the likelihood of a sequence both with respect to the conventional keyboard and the distorted keyboard, given the statistics of the language. This computation would be evident to those skilled in the arts of statistics and probability theory. Then, a user-adjustable parameter which sets a threshold such that sequences which are closer than the threshold in likelihood are not automatically rewritten, while when sequences are far apart in likelihood, and the conventional sequence is most likely, the distorted sequence is replaced with the convention sequence.

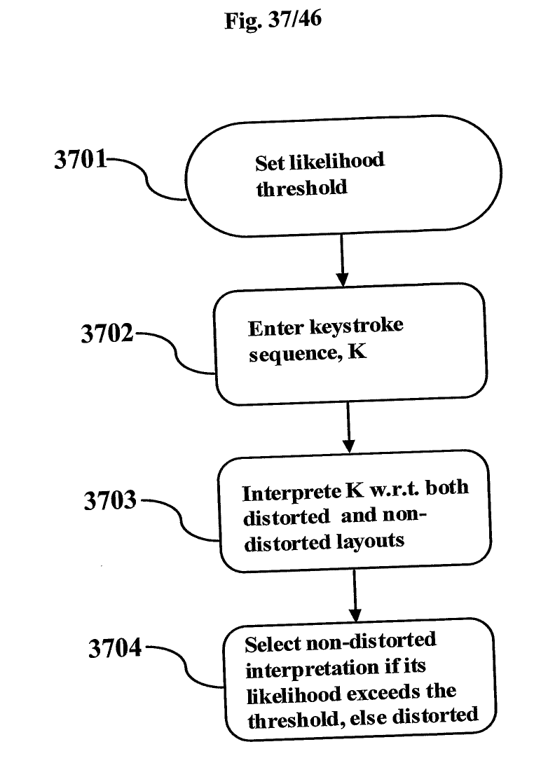

Referring to FIG. 37, we describe in more detail how this aspect of the invention performs.

Step 3701: A likelihood threshold is set. This setting might be under user control, or might be set in hardware or software, perhaps on the basis of analysis of user behavior. The likelihood threshold determines the relative weight given to the conventional keyboard or the distorted keyboard interpretation of keystroke sequences.

Step 3702 A letter sequence K entered by user

Step 3703 software computes possibly intended sequence assuming both distorted and non-distorted keyboard.

Step 3704 If the sequence is significantly more likely when interpreted as typed on the non-distorted keyboard, then the non-distorted interpretation is output, otherwise, the distorted keyboard interpretation is output.

### Selecting for Reduced Number of Shifted Letters or Probability of a Shifted Letter

This embodiment provides an example of how the teachings of the instant invention can incorporate the teachings of Gutowitz '317 regarding hybrid chording/ambiguous codes. More specifically, order and partition distortion can be combined with optimal selection of symbols to be selected by a chording mechanism. It should be evident that “chording” in this context can mean any mechanism for distinguishing a subset of letters from a set, such as the set of letters assigned to a given key.

To provide concreteness but without any attempt at limitation, the present embodiment is described in terms of a gaming device. On this gaming device the letter-assigned keys are not labelled with letters at all. The main purpose the machine is to play games, not to enter text, and the keys are labeled to serve the gaming purpose. It is thus important for this embodiment, as it has been for other embodiments, that the assignment of letters to keys be simple to learn and memorize.

It serves our purposes, therefore, to limit the number of letters which are produced by chording. To meet this limitation, and yet to simultaneously optimize typability, order and partition distortions must be chosen with care.

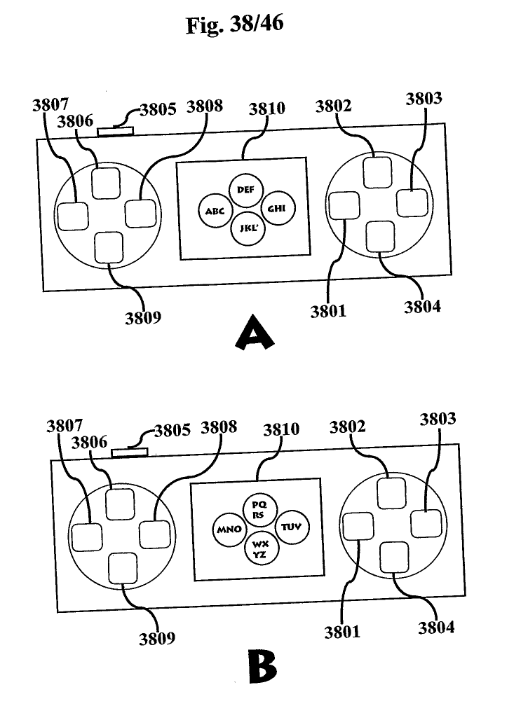

Turning to FIG. 38, we see a gaming device with a screen (3810), a shift key (3805), a set of directional keys designed to be operated with the thumb of the left hand (3806-3809) and a set of keys designed to be operated with the thumb of the right hand (3801-3804). If we take the conventional ordering to be the alphabetic ordering of English, and the conventional partition to be the standard partition of the letters onto the telephone keypad, we can map the convention onto the gaming device in the following way: Let each of the four keys (3801-3804) represent a key of the telephone keypad, and another four keys of the telephone keypad when they are activated in conjunction with the shift key (3805). For instance, one could assign (abc,def,ghi,jkl) to (3801-3804) in the unshifted state (FIG. 38A), and (mno,pqrs,tuv,wxyz) to the same keys (3801-3804) in the shifted state (FIG. 38B). This code would have exactly the same typability as the standard ambiguous code on the telephone keypad (6.0 effective keys, using our standard statistics for English). In FIGS. 38A and 38B, as an aid to the user, the assignment is shown on the screen (3810). Preferably, this display could be turned off if the user became expert enough to not need to be reminded of the letter-to-key assignment. It should be evident that other symbols instead of or in addition to the letters a-z could be assigned to keys in this embodiment. It should also be clear that mechanisms other than a shift key could be used to distinguish a subset of the symbols assigned to each key, and that other conventional orderings than alphabetic ordering could be used as a basis of this embodiment.

We may find an alternate assignment which a) improves typability as measured by effective key number, and b) improves learnability as measured by the number of letters one needs to remember are associated with the shift by:
a) generating all possible partitions of the letters in alphabetic order such that there are 8 non-empty partition elements,
b) selecting a partition which has
   i) a high effective key number,
   ii) as few as possible letters in the shift mode.
   iii) to the extent possible, an alternation of larger-than-average and smaller-than-average number of letters in a partition element. This helps achieve ii) while reducing order distortion.

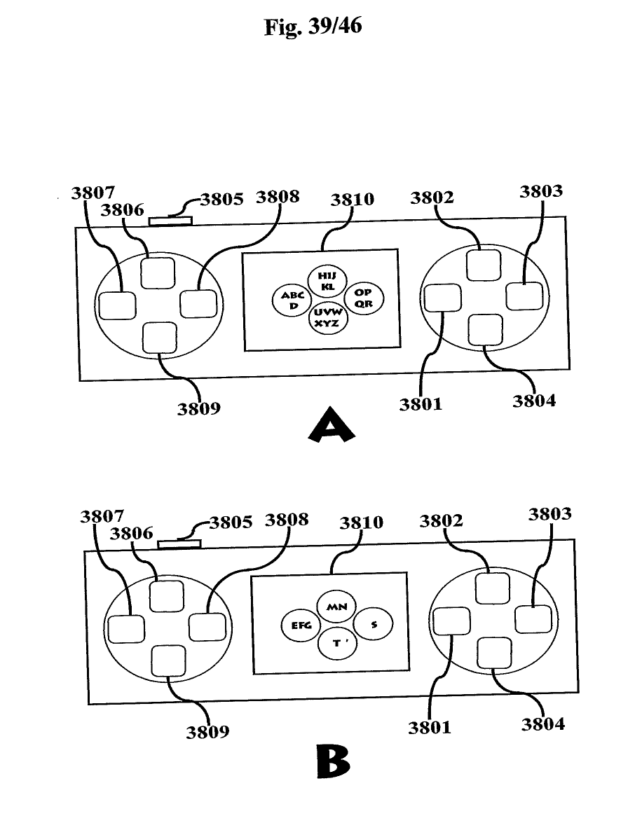

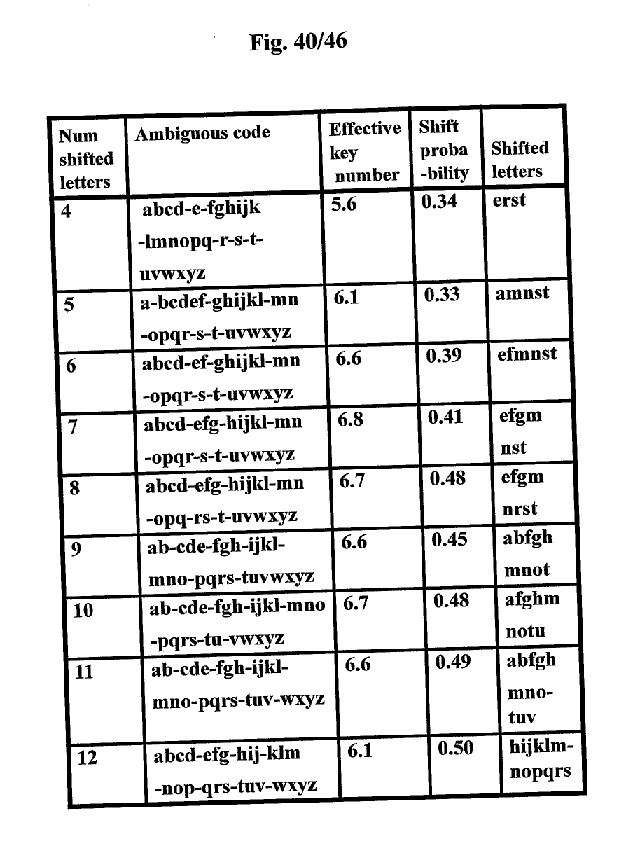

Applying these criteria allows us to find letter-key assignments which are optimized both for typability and for learnability. An example layout is shown in FIG. 39, where the unshifted, shifted letter-key assignments are shown on the screen (3810) in FIGS. 39A and 39B respectively. In alphabetic order, the code is abcd-efg-hijkl-mn-opqr-s-t-uvwxyz. It has an effective key number of 6.8, and a lookup error rate of 42 based on our reference statistics. This is a significant improvement over the standard telephone keypad code. The higher-than-average and lower-than-average partition elements nearly alternate when the elements are in alpha, and can be made to alternate with minimal order distortion: (abcd,hijkl,opqr,uvwxyz) assigned to keys (3801-3804) in the unshifted mode (FIG. 39A) and (efg,mn,s,t) assigned to keys (3801-3804) in the shifted mode (FIG. 39B). Thus there are only 7 shifted letters, reducing the amount of memorization required to learn this code relative to the standard telephone code. It will be appreciated that the limitations of alternation of larger-than-average and smaller-than-average partition elements, and reduction in the number of letters in shifted mode are a benefit to learnability but may be in conflict with optimization of typability. Turning now to FIG. 40, we see a table of codes adaptable to this situation, but varying in the number of shifted letters, from 4 to 12. For each number of shifted letters, the ambiguous code with the highest effective key number is shown. Also shown is the total probability of the shifted letters, and the set of shifted letters, in alphabetic order.

### Alternate Embodiment Based on Minimizing the Probability of a Shifted Letter

The code of FIG. 39 corresponds to the line with 7 shifted letters in the table of FIG. 40. Its effective key number is the highest of any in this sample, which is why it was chosen above. If the learnability constraint were judged more important than the typability constraint, then the code in FIG. 40 with four shifted letters might be chosen instead. The shifted letters for this code “erst” are particularly simple to remember. Unfortunately, the four-shifted-letter code has an effective key number of only 5.6, even less than that of the standard telephone code. In another situation, typability might be judged to be best measured by the minimal probability of a shifted letter combined with a high effective key number. This would lead to the choice of the five-shifted-letter code of FIG. 40, which has the lowest probability of a shifted letter, 0.33, among the codes of FIG. 40. Its effective key number, 6.1, is just greater than that of the standard telephone code. An intermediate weighting of the various criteria might lead to the choice of a still other code. Any such choice which involves a typability maximization with a distortion minimization would be within the scope of this invention.

### Variable-Layout Embodiment

Thus far we have considered distortion-minimized and typability-optimized solutions for a single keyboard. However, a given person may possess several devices with different keyboards, and it would be beneficial to them to have a layout which differs minimally from one keyboard to the next. It would be beneficial, therefore, to maximize typability and minimize distortion across a range of keyboard geometries. One way to provide this is non-limitatively illustrated by the embodiment to now be described.

This embodiment is such that
a) The same order distortion is used for all keyboards in the sequence, and,
b) optionally, when keys are operated in combination to select letters, the same combinations are used for the same letters for all keyboards concerned.

As a non-limiting example, consider the case of qwerty-like keyboards on n-columns. Imagine a sequence of such keyboards all meant to be operated by the same person in potentially rapid succession. Our desire is that, without having to retrain their reflexes, users could easily and efficiently use any of the keyboards in the sequence.

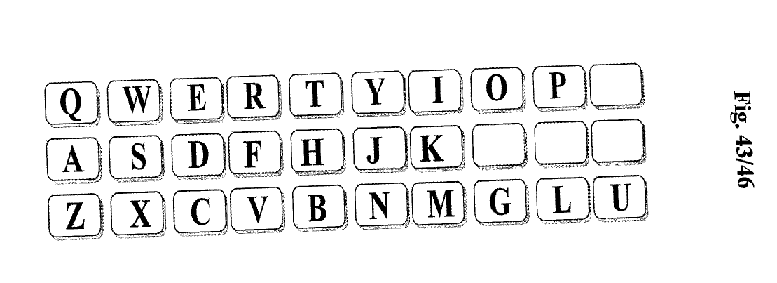

To fix one end of the range, we will take as a non-limiting example, the 3-column qwerty-like keyboard of FIG. 23. This keyboard may be “expanded” as far as an unambiguous 10-column keyboard with the same order distortion, as shown in FIG. 43. In between these extremes are a range of keyboards, each with the same order distortion, though potentially different partitions, each element of the range adopted for a different device form factor. For instance, a device whose primary functions are phone-like might use a 3-column version, a primarily handheld data terminal device might use a 4-6 column version, and a device with laptop-like functionality might use a 7-10 column version.

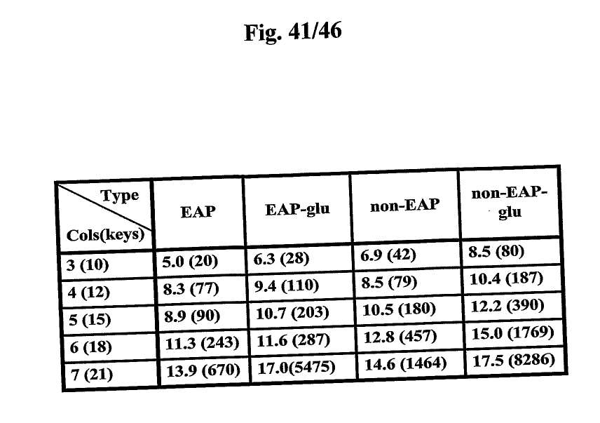

Turning now to FIG. 41, we see the relative effects of order and partition distortion for a range of keyboards. As a non-limiting example, we will use effective key number as our measure of typability for this embodiment. The first column of the table of FIG. 41 gives the number of columns of a qwerty-like keyboard, followed by the number of letter-assigned keys in parenthesis. Notice in particular that the 3-column keyboard is listed as having 10 letter assigned keys, corresponding to the letter-assigned keys of FIG. 23. There are four data columns in the table of FIG. 41. Each data entry follows the format: effective key number (Lookup error rate). The effective key numbers and lookup error rates are calculated from the same reference data as used throughout this disclosure. The first data column, labeled EAP, presents the best qwerty-like code found with no order distortion and an even-as-possible layout. The second data column, labeled EAP-glu gives the values for the best order-distorted keyboard having the same order distortion as the keyboard of FIG. 23, with an even-as-possible partition. The third data column, labeled non-EAP, gives the results for the best qwerty-like non-even-as-possible, non-order-distorted layout found. The fourth data column, labeled non-EAP-glu, gives the results for the best non-even-as-possible partition with an order distortion as in FIG. 23.

Several remarks regarding this table are in order.
a) These data show that order-distortion and partition distortion can combine synergistically to produce more highly typable keyboards. Either of order distortion or partition distortion alone can improve the typability of the keyboard, but neither alone is as effective as both in combination, for the all of the keyboards in the range of 3-7 columns. We can easily anticipate that this effect would also be observed for other keyboards of different layouts.
b) While the even-as-possible, non-ordered-distorted keyboard on 3 columns has worse typability than the standard ambiguous code, either order distortion or partition distortion are enough to produce a qwerty-like code in this geometry which is better than the standard ambiguous code, and both used together produce a keyboard which is even strongly touch typable in the terms of Gutowitz '317.
c) The order- and partition-distorted keyboard with 6 columns is of better typability than the hybrid chording/ambiguous code of Gutowitz '317 as applied to the telephone keypad, as are any of the variants with 7 columns. They achieve these results without the use of a shift key, but using more letter-assigned keys. Very roughly speaking, order and partition distortion together used with a qwerty-like layout give results which are competitive with optimal hybridization of chording and ambiguous codes as applied to an alphabetic order. As has been discussed in more detail with respect to other embodiments, all three methods, order distortion, partition distortion, and chording hybridization can be synergistically combined together to produce still further typability improvements to any of these layouts.
d) It would be beneficial to use the same shifted letters for all of the keyboards in a given variable-layout family. In that way, the gestural habits used on one keyboard in the family may be adopted immediately for use on another member of the family. In some instances, a shifted letter which is on the same key as an unshifted letter in one member of the family, but on its own key in a second member of the family. In this case, it would not be necessary to perform the shift to input that letter in the second member of the family. The software could be configured so that either the shifted or unshifted state would input the same letter, so as to not cause difficulties for the user using either member of the family in potentially rapid alternation.

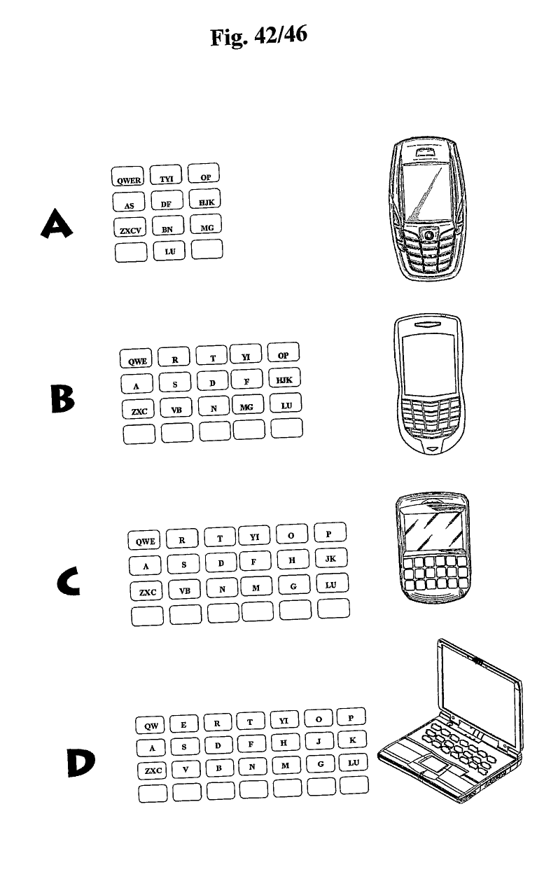

Turning now to FIG. 42, we see how the expanded variants of the keyboard of FIG. 23 might be associated with devices of different form factors. FIG. 42A shows the 3-column layout of FIG. 23 paired to a telephone, FIG. 42B shows a 5-column layout paired to a telephone-like device which also has some data features, FIG. 42C shows a 6-column layout paired to a mainly data device, and FIG. 42D shows a 7-column layout paired to a laptop-like device. Users who familiarize themselves with the order distortion by using any one of these devices could immediately adapt to any other one of the devices. At the same time, the device designer can chose a keyboard which produces the best typability possible with their device, with acceptable key size. This is in striking contrast to the prior art where designers of small devices attempt to shoehorn a full qwerty keyboard onto the device by making the keys unusably small.

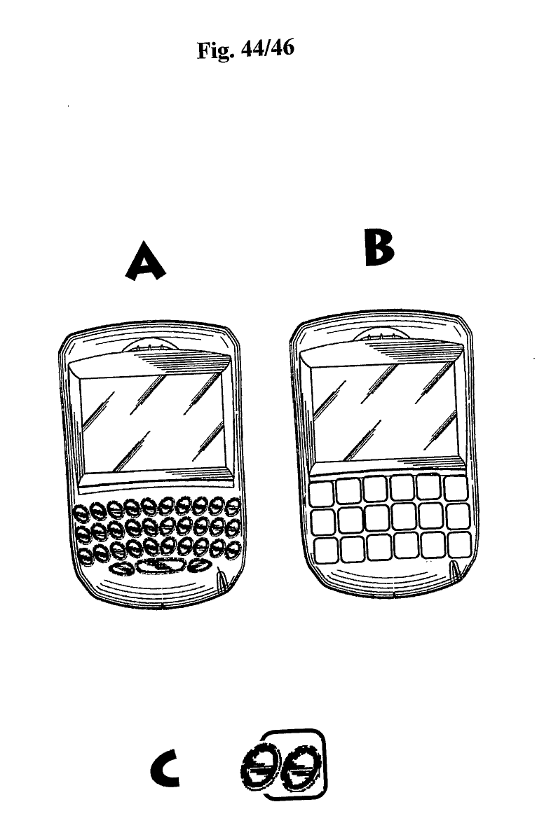

To stress this point, we now turn to FIG. 44. FIG. 44A shows a prior-art handheld data device with a full qwerty keyboard. FIG. 44B shows the same device modified according to this invention to support a 6-column layout. FIG. 44C shows two keys of the prior-art device of FIG. 44A laid out on top of a single key from the novel device of FIG. 44B. It is seen that the novel keys are much bigger than the prior-art keys, and thus much easier to press with the fingers or thumbs of adult humans.

Given the forgoing, combined with the previously discussed embodiments, it should be clear that within the general framework of this aspect of the invention, which seeks to conserve order distortion across a range of keyboards, it is possible to make many variants which remain within the scope of the invention. For example, the above-described sequence of keyboards was designed to maximize typability across all keyboards in the sequence, and choosing partition distortions only on the basis of typability with respect to word guessing. One might also or instead optimize typability with respect to some other disambiguation mechanism. One might also or instead choose partitions for some elements of the sequence so as to be even as possible, of small range, symmetrical, or some other criteria, which criteria need not be the same for all elements of the sequence. It is further clear that while this sequence of keyboards was designed with qwerty and English in mind, any conventional keyboard and any set of languages could be treated with the same methodology as is taught herein.

### Implementation of the Variable-Layout Embodiment

Implementation of the variable layout embodiment entails numerous subsidiary problems which can be resolved through the application of additional inventive insight. Three broad classes of problems, along with their solutions, will now be disclosed. These problems, though particularly acute in the context of variable layouts, may arise in much broader contexts, without reference to variable layouts. The three classes of problems are 1) the assignment of punctuation and digit symbols to keys, 2) the definition of user functions which aid word-based or context-based disambiguation, and 3) the assignment of symbols from multiple languages simultaneously to the same set of keys.

### The Assignment of Punctuation and Digit Symbols

Gutowitz and Jones '264, hereby incorporated by reference and relied upon, disclosed an easy-to-remember scheme for assigning punctuation to keys such that the morphic and functional similarity between symbols, in particular between punctuation symbols and digits, is maximized. A problem to be grappled with in applying the invention of '264 to the variable-layout embodiment of the present invention is that the number of keys varies. In particular, the number of keys may be greater than or less than the number of digits. In the case of number of keys less than the number of digits, one strategy is to place several digits on a key, and provide some mechanism for selecting which digit is needed. In this case, the punctuation-digit associations of '264 may be applied directly; every digit assigned to a key will have its morphically similar punctuation assigned to the same key. In the case that the number of keys is greater than the number of digits, morphic similarity as taught by '264 may still be used to select an assignment of symbols to keys which is easy to remember and discoverable. The preferred scheme for the variable-layout embodiment is to extend the concept of digit to “digit mode” and the concept of punctuation to “punctuation mode”. Symbols in digit mode are preferable digits themselves or digit-like symbols, in a discoverable sense. Similarly, symbols in punctuation mode are punctuation symbols themselves, or symbols which are discoverably “punctuation like”. By selectively adding symbols to both modes as the layout grows in key number, the morphic similarity between digit symbols and punctuation symbols can be extended to cover the entire range of variable layout size.

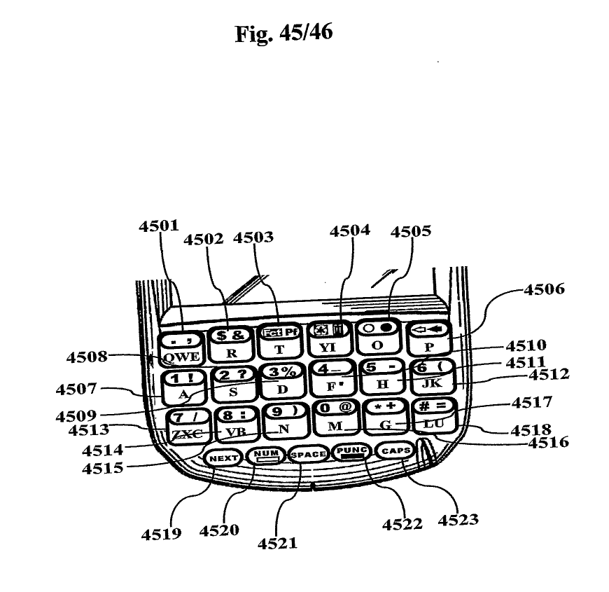

A non-limiting example of a layout produced by this method is shown in FIG. 45. In FIG. 45, each of the keys 4501-4518 is able to input symbols in any of four modes: alphabetic lower case, alphabetic upper case, digit, and punctuation. The keyboard is equipped with mode keys 4520,4522,4523 to cause the keyboard to enter digit, punctuation, and alphabetic upper case mode respectively. It also has a Next key 4519 effective to produce either the next ambiguous word or next ambiguous character, depending on whether word-based or character-disambiguation is used in the current mode.

If no mode key is pressed, then the keyboard is in the default alphabetic lower case mode. Each of the keys 4501-4518 comprise an upper and a lower region. In the upper region, symbols from digit and punctuation modes are shown, and in the lower region, symbols from the alphabetic modes are shown. To enforce the relationship of digit mode symbols with the digit mode key 4520 and the relationship of punctuation mode symbols with the punctuation mode key 4522, the digit mode symbols are in the left part of the upper region of each key, and the digit mode key is on the left part of the keyboard. Similarly, the punctuation mode symbols are to the right, as is the punctuation mode key.

In the 6-column keyboard there are 18 letter keys. In digit mode, once the digits themselves are assigned to keys, There are 8 keys remaining. There are two assignments of additional symbols to digit modes which follow the functional similarity approach of '264, * and #. Both of these symbols are commonly referred to as “digits” by telecommunication engineers, since they occur in standard telephone keypad layouts. The symbol . (period) is often used to punctuate digits, and so can be understood with relatively little functional distortion as a digit itself, and thus easily remembered as being part of digit mode. The national currency symbol is also commonly associated with numbers, and thus functionally belongs in digit mode. In the non-limiting example of FIG. 45, the device shown is imagined to be destined for the American market, and thus the dollar sign is shown in digit mode on key 4502. The dollar sign is paired to the ampersand in punctuation mode on key 4502, since the ampersand is morphically similar to the dollar sign. The assignments to digit mode for the remaining four keys will be discussed below in the context of functions for word-based or context-based disambiguation.

In punctuation mode, 10 punctuation symbols are associated with digits in direct application of the teachings of '264. An additional four punctuation symbols are associated with the corresponding members of digit mode on the same key so as to maximize morphic and/or functional similarity. Thus the (digit,punctuation) pairs (*,+), (#,=), (.,,), and ($,&) are associated to keys 4517, 4518,4501,4502 respectively. The punctuation mode symbols for the remain four keys will be discussed below in the context of functions for word-based or context-based disambiguation.

For layouts in the family of variable-range keyboards with a greater number of keys, still other symbols could be added to both digit and punctuation modes following as well as possible the morphic and functional similarity scheme set up by the original set of 10 (digit,punctuation) pairs. Conversely, layouts in the family with fewer keys would have fewer symbols in both modes.

Given this non-limiting example, we may now state the instant teaching for adopting the invention of '264 to the variable-layout embodiment.
Symbols in digit mode are, to the extent possible, digit-like in shape and/or function.
Symbols in punctuation mode are, to the extent possible, punctuation-like in shape and/or function, and related in shape and/or function to the symbol or symbols in digit mode on the same key.
The set of symbols in both digit and punctuation mode for a keyboard in the family of variable-layout keyboards with number of keys=n>m contains the set of symbols for the keyboard in the family with number of keys=m.

If a separate mode key is available for digit mode and punctuation mode, it is preferable that the mode key for digits is placed on the side of the keyboard corresponding to the side of the key on which digit symbols are placed, and correspondingly for the punctuation mode key and the punctuation symbols. In the case of fewer available keys, several mode-changing functions may be assigned to a single key.

### Definition of User Functions which Aid Word-Based or Context-Based Disambiguation

When word-based or context-based disambiguation is available, alone or in combination with character-based disambiguation, it is desirable to provide a variety of functions to a) manage changes between word-based or context-based and character-based disambiguation b) manage the lists of words which are truly ambiguous, and c) manage the user dictionary, if available.

An aspect of this invention is to provide these functions in a way which
is compatible with the variable-layout embodiment of this invention, as well as fixed-layout keyboards,
I) provides as many functions as possible directly from the base mode, including the most important functions,
II) does not require more than one function to be done with a single keystroke or gesture, and yet provides for functions to be selectably combined,
III) assigns functions to keys in sensible and easy-to-remember way,
IV) is laid out such that functions are easy to perform using two thumbs in combination, especially in view of steric hindrance.

To see how these desirable features might be inventively implemented, we will now consider a non-limiting example set of functions to be provided, and a non-limiting example of assignment of these functions to a member of a family of variable-layout keyboards.

We may arrange the functions into five broad groups.

Display Management Functions:
next ambiguous word
next ambiguous letter
delete word from display
delete character from display
complete word

Prediction Mode Management Functions:
enter alternate text-input mode
enter home mode
undo last retroactive change

Character Mode Management Functions:
enter punctuation mode
enter digit mode
enter capitalization mode
return to home mode
make mode sticky/unsticky

Dictionary Management Functions:
insert word in dictionary
delete word from dictionary
reorder ambiguous words

Additional Management Functions:
enter preferences menu
enter further functions menu

Consider first the group of display management functions. Each of these functions operates on the current word being entered or which has just been entered. With a word-based or context-based disambiguation system, a sequence of keystrokes are entered and compared to a dictionary of reference words. Several different events may occur, and each requires a different action from the user. These non-limiting example of events and required actions include:
Event: There is exactly one word in the dictionary which corresponds to the keystroke sequence, and it is the intended word. Action: the user should simply continue typing.

Event: There is exactly one word in the dictionary which corresponds to the keystroke sequence, and it is not the intended word. Event: erase the word, re-enter the word with a different input method, either a non-ambiguous method or a character-prediction mechanism.
Event: There are several words in the dictionary which corresponds to the keystroke sequence, including the intended word. Action: scroll the list of words until the intended word appears.
Event: There are several words in the dictionary which corresponds to the keystroke sequence, but none are the intended word. Action: scroll though the entire list of words until it is verified that the word is not found. Then delete the word, and re-enter the word with a different input method.
Event: The user realizes that a typing mistake has occurred Action: delete characters one-by-one until the result of the mistaken keystroke is deleted.
Event: The user anticipates that the system can properly complete the word based on an initial few characters. Action: activate word completion.
Event: The user anticipates that the system will not display the correct word, even if all keystrokes are entered properly, since it has performed an unpromising retroactive change. Action: undo last retroactive change, enter alternate text-entry mode.

These actions all include at least one display management function, but may include other functions as well, such as prediction mode management functions. Three prediction mode management functions are listed above, though there may of course be others. Entering the alternate input mode is required, e.g. when an intended word is not in the dictionary, so word-based disambiguation will not work and context-based disambiguation may not work. The user may be provided also with a function to re-enter the home mode. The “undo last retroactive change” functionality is described in detail in '264. Its has the effect of helping the user avoid deleting an entire word if it is believed that word-based or context-based will not work to correctly display the intended word. It undoes only the last retroactive change, leaving the previously entered beginning of the word intact.

The set of character mode management functions is relatively straight forward. Given the assignment of all of digits, punctuation, and letters to keys as described in detail above, it is preferably to allow the user to select which of these types of symbols will be input. It is preferably, therefore, to provide the user with functions to enter, digit, punctuation, and capitalization mode, as well as to return to the home mode, which in this example is lower-case alphabetic mode. It is preferably to provide a function to make any given mode be “sticky” that is to set the keyboard so that it remains in the given mode until “unstuck” by another function. A familiar example of such a function is the Caps Lock function. However, any of the modes could be made to lock, and there might distinct function to lock each mode, or a generalized function applying to which ever mode is current.

A word-based disambiguation system depends on a dictionary of words. No dictionary of finite size can contain all the words or, more generally, sequences of symbols, that a user may wish to input. To reduce this problem, one may provide the user the ability to augment the dictionary with new words. A function to insert words in the dictionary may therefore be provided. Conversely, it may be desirable to eliminate words stored in the dictionary, for instance if they are rarely used or misspelled. There may be several words in the dictionary which correspond to the same keystroke sequence. These will be presented to the user in some default order, determined for example by the probability of the words, time of last use of the word, or some other automatic scheme. The user may wish to change that default order, and a function for this may be provided.

This long list of functions which aid a user in typing with an ambiguous keyboard is still incomplete. Even with a keyboard with many keys, it may be necessary to make these additional functions available not from the keyboard, but from a software-generated menu. A single keyboard board function would be required to access the additional function menu.

Further, new functions may be generated by association of elementary functions into macro functions. These macro functions would be particularly useful to users who often use given sequences of elementary functions. One aspect of this invention is to identify particular macro functions of surprising utility for word- and context-based disambiguation mechanisms. A further aspect of this invention is to assign elementary functions to keys such that the discoverability, usability, and configurability of the keyboard is maximized.

These aspects will now be described in reference to FIG. 45. The assignments of letters, digits, and punctuation symbols to many of these keys was discussed above. The above described assignments left digit and punctuation mode available for use on keys 4503-4506. The problem to be solved is to provide as many of the functions described above as possible, while satisfying the criteria I-IV announced at the beginning of this section.

First consider criterion I, which is that the layout should provide as many functions as possible directly from the base mode, including the most important functions. For any number of keys, there is always a tradeoff between the satisfaction of criterion I, and the criteria of minimization of distortion and maximization of typability. Keys in base mode could be used to provide either functions or for letter assignment. The more keys which are used for letter assignment, the better the typability, other things being equal. The application of the teachings of this aspect of the embodiment must not be understood as limited to the particular keyboard of FIG. 45. Indeed, our goal in this embodiment is to satisfy criterion I while allowing keyboards which are similar in the sense of belonging to the same variable-layout family to have similar function-to-key assignments as well as symbol-to-key assignments. It will be appreciated that criterion I could be applied in a much broader context than the present embodiment.

For the keyboard of FIG. 45, the functions Next word or Next letter 4519, enter digit mode 4520, enter punctuation mode 4522 and enter upper case mode 4523, are all given separate keys, making these function available in base mode, indeed any mode. This satisfies criterion I for these functions. Other functions are available in either digit or punctuation mode, or via a menu.

Let us now consider criterion II, which states that a layout should not require more than one function to be done with a single keystroke or gesture, and yet provide for functions to be selectably combined. To see how criterion II might be satisfied for the keyboard of FIG. 45, together with satisfying criterion III, we will introduce eight additional functions, available in the single gesture of pressing either the digit mode key (4520) or the punctuation mode key (4522) in combination with one of the letter-assigned keys (4503-4506).

These eight functions are arranged in four pairs of similar functions. The first pair consists of menu-entering functions, the enter further functions menu function, obtained by pressing the digit mode key 4520 in combination with key 4503, and the enter preferences menu function, obtained by pressing the punctuation mode 4522 key in combination with key 4503.

The second pair consists of word deletion/demotion functions. Represented by a recycle symbol on key 4504, the demote word function is obtained by pressing the digit mode key 4520 in combination with key 4504. Represented by a trash can on key 4504, the delete word from dictionary function is obtained by pressing the punctuation mode key 4522 in combination with key 4504.

The exact different between these two functions may depend on implementation details and on user preferences, but deletion of a word is clearly more aggressive than reordering of words. In a typical implementation, “delete word” would remove a word completely from the dictionary. It may be that deletion is limited to words which had been previously added by the user. “demote word” would typically move the given word to the bottom of the list of alternatives for a given keystroke sequence. It might also, for example, be set to move the word down one in the list, rather than completely to the bottom of the list. Clearly, repeated application of the word demotion function could serve to put the list in any desired order.

The third pair of functions change the aggressiveness of the prediction function. Represented by an filled circle on key 4505, the word completion function is obtained by pressing the punctuation mode key 4522 in combination with key 4505. Word completion will fill in the rest of the word based on the system's best guess as to which word is intended by the user, based on the part of the word already entered. This is an increase in the aggressiveness of prediction. Represented by an open circle on key 4505, the enter alternate text-entry mode function reduces the aggressiveness of prediction. The alternate text-entry mode, typically character-based prediction, is less aggressive than the default mode, typically word-based prediction. The character-based prediction attempts only to predict the next letter, rather than the whole word. Word completion is more aggressive than standard word-based prediction in that it predicts letters even for keystrokes which have not yet been made. The enter alternate text-entry mode function is obtained by pressing the digit mode key 4520 in combination with key 4505. The visual distinction of filled vs. empty is here used to suggested more vs. less aggressive, and the theme is carried as far as possible to other pairs of functions. It will be appreciated that other visual distinctions could be used for this purpose.

The fourth pair of functions are delete from the display functions. Represented by a filled left arrow on key 4506, the delete word function deletes the last word from the display, but does not remove it from the dictionary. It is obtained by pressing the punctuation mode key 4522 in combination with key 4506. Represented by a open left arrow on key 4506, the delete character function deletes the last character from the display, and does not alter the dictionary. It is obtained by pressing the punctuation mode key 4520 in combination with key 4506. As in the case of the assignments of functions to keys 4504 and 4505, these assignments to 4506 a) put similar functions on the same key, and b) place the less aggressive of the pair of functions on a given key in digit mode. This extends the teachings of Gutowitz and Jones '264, by arranging functions by functional similarity and class. This extension, combined with the extension of the concept of digit to the concept of digit mode, and punctuation to punctuation mode serves to satisfy the above announced criterion III.

### Adopting to Other Members of the Variable-Layout Family

As the number of keys increases relative to the layout of FIG. 45, new functions can be added to both digit and punctuation mode. As the number of keys decreases relative to the layout of FIG. 45, functions can be combined, or moved to a menu. For instance, the function of deletion of a word from the display can always be obtained by iterated application of the delete character from display function, so delete word from display can be dropped or moved to the function menu in the case of fewer keys. Similarly, the function menu and the preferences menu can be combined into a single menu. Careful application of the teachings of Gutowitz and Jones '264 as non-limitatively illustrated above can aid the user in adopting from one member of a variable-layout family to another.

### Selective Combination of Functions

In the exemplary list of word-based disambiguation event/actions above, there are several actions which involve a sequence of elementary functions. For instance, when there are several words in the dictionary which corresponds to the keystroke sequence, but none are the intended word, one may a) scroll though the entire list of words until it is verified that the word is not found, b) delete the word, c) switch to an alternate text-input method, and d) re-enter the word with the alternate text-input method. If this is a common action, the user may prefer to link the actions of b) and c), so that a single keystroke or gesture will perform both. These actions should not be linked by default since i) complicated actions are hard for novices to master, and ii) some users may prefer to keep these actions separate, or combine them in different ways. For instance, another user might like to make a still longer chain of actions consisting of b) delete the word c) switch to an alternate text-input method, and e) add the word to the dictionary once typed, in the lowest position. Still another user might prefer the latter sequence, but with the added word made first in the list.

This aspect of this invention solves these problems for all of these users by supplying easily accessible atomic functions, combined with a mechanism for linking the atomic functions into compounds.

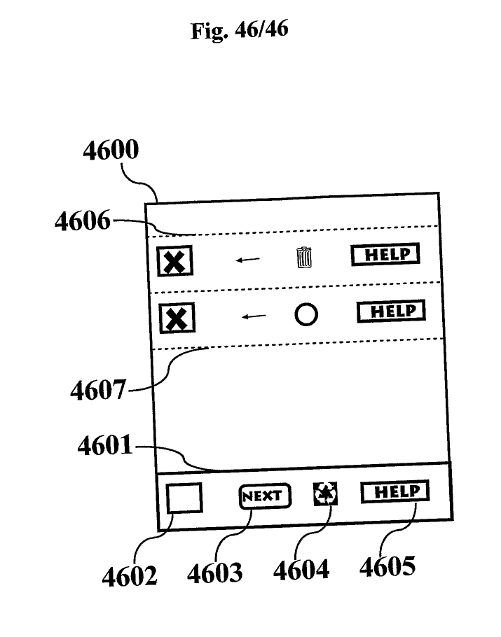

Turning to FIG. 46, we see a non-limiting example of a link/unlink mechanism 4600, implemented as a link/unlink menu. The link/unlink menu allows users to set up preselected combinations of atomic functions. Preferably, it also allows the user to define combinations of atomic functions. In this embodiment, a function designer 4601 appear in the link/unlink menu 4600. It has 4 components: 1) a checkbox 4602. If checked, the items are linked, and moved to the top portion of the menu, as for example linked action sequences 4606 and 4607. 2) the icon of the first function 4603, 3) the icon of the second function 4604, 4) a help function 4605.

The function designer may be used in a number of ways. A first way, which we will called help-driven, is to scroll through the list of help messages 4605. Each message is a description of what a function combination of first and second functions will achieve, explaining the advantages and disadvantages of each. If the user wants to perform that action, they link the functions by checking the checkbox 4602. A second way to design links is to scroll the first icons 4603, and then second icons 4604. The help function will then explain apply to the chosen combination. Note that not all combinations of first and second functions may make sense for text entry, and the menu will preferably limit the choice of second function to only those second functions which are reasonable given the current choice of first function.

Once two functions have been linked, they appear in the link/unlink menu with a checkbox, checked. Some examples are shown 4606 and 4607. Preferably, if any of the function combinations are unlinked by unchecking the corresponding box, they disappear from the menu, keeping the number of items in the menu small.

Non-limiting examples of function combinations which some users may prefer include:
Next character+enter alternate text-entry mode. When Next character is pressed in word-based disambiguation mode, the typical situation is that the user has lost confidence in the system to correctly find the intended word. Therefore, they may prefer that the system enters alternate text entry mode for the input of the rest of the word. The system may be set to revert to word-based disambiguation when a non-letter character is input.
enter alternate text-entry mode+revert last retroactive change. If context-based disambiguation has made a retroactive change which the user does not believe will lead to correct input of the intended word, they may wish to both undo the last retroactive change and enter alternate text-entry mode to complete the word with more complete control.
delete word from display+enter alternate text entry mode. When an entire word is deleted from the display in a context-based disambiguation mode, it will typically be the case that the system has failed to correctly guess the intended word. The user will then want to both delete the word from the display and enter alternate text-entry mode so that the intended word can be properly input.
space+enter home mode. When the basic text entry mode is chosen to be context-based rather than character based, there may be instances, as described above, where a temporary retreat to character-based input mode is needed. It may be preferable to revert to home context-based mode whenever a symbol, such as space, is input, thus ending the word.
enter alternate text-entry mode+insert word in dictionary when it is complete. When context-based disambiguation fails to display the intended word and/or the user anticipates that context-based disambiguation will fail on the next intended word, they may wish to both enter alternate text entry mode, and have the word thus entered be inserted into the dictionary for possible use in the future.
delete word from display+delete word from dictionary. A user may decide to only use the delete word function when context-based disambiguation has clearly failed. In this case, they may wish to ensure that the displayed letter sequence not be presented as a prediction in the future.

These and many other combinations can be made from the atomic functions described about. Subsets of such combinations may be preloaded as a style. That is, some collection of linked functions may be appropriate for a beginner, and other collections for an expert, and these collections could be made available for selection by the user, without requiring them to manually link all of the appropriate functions. Clearly, once two atomic functions are linked, they could be further linked to form longer action sequences.

### Optimizations for Two-Thumb Typing

We consider finally criterion IV, which states that it is desirable that the layout be such that functions are easy to perform using two thumbs in combination, especially in view of steric hindrance. Reduction of steric hindrance entails that any gesture to be performed by two thumbs pressing two keys, substantially simultaneously or in quick succession, should be performed on keys which are separated from each other as far as possible.

It should be noted that the prior art has focused on making small-device keyboards which are quick to use with a single finger, thumb, or stylus. The art has concentrated, therefore, on placing symbols which are often used together in sequence close to each other to reduce the time to move from one key to another. The present teaching is the opposite in that keys frequently used in combination should be as far as possible from each on the keyboard. Since one element of the sequence will be pressed with one thumb, and the other element of the sequence with the other thumb, it is important to place keys frequently used in combination where the thumbs will not interfere with each other. In the present instance, it is expected that function keys will used more frequently than digits. In particular, data suggests that the backspace key is used very frequently in actual typing. Therefore, the function keys, as well as common punctuation, such as period or common, should be placed on the top row of the keyboard, when possible, as far away as possible from the mode changing keys on the bottom row. Such an arrangement is shown in FIG. 45. It will be appreciated that the arrangement of FIG. 45 may not be compatible with all members of a variable-layout family. In particular, for the 3-column layout discussed above, an arrangement of the digits in the familiar telephone keypad fashion may be preferred.

It should be appreciated that many variations are possible with respect to these illustrative embodiments without departing from the scope of the invention. In particular, making differences in natural language, conventional reference layout, keyboard geometry, distortion measure, hindrance measure, drummoll effect measure, or interaction mechanism are fully evident to one skilled in the art in view of this disclosure.

It is painfully obvious to those of even less than average skill in the art to use any of the above embodiments in combination with flourishes added to basic word or character-based disambiguation, such as a) word completion, b) phrase completion, c) a user dictionary, d) across-word prediction e) additional keys to input additional symbols (such as punctuation marks, short-cuts), indeed, any disambiguation mechanism can be improved via diligent application of the discoveries and techniques revealed in the present disclosure.

Therefore, the scope of the invention should not be judged merely from the superset of all possible combinations of aspects of these embodiments, but from the appended claims.

What is claimed is:

1. An apparatus comprising an ambiguous keyboard; said ambiguous keyboard comprising keys; symbols; said symbols characterized as assigned to said keys, said symbols further characterized as divided into conceptually disjoint subsets, such that all of said symbols ambiguously input by said ambiguous keyboard are in one of said disjoint subsets, and all members of a given of said disjoint subsets are assigned to a given of said keys.

2. The apparatus of claim 1 further characterized in that said symbols are letters, and said disjoint subsets consist of the set of vowels and the set of consonants in a language.

3. An apparatus comprising an ambiguous keyboard; said ambiguous keyboard inputting symbols; said symbols characterized as containing at least one symbol selected from the set consisting of functional and letter symbols; and where said at least one symbol possesses a multiple representation on said ambiguous keyboard; said multiple representation characterized in that each representation is assigned to a different one of said keys, and further characterized in that said different of said keys are arranged so as to minimizes steric hindrance.

4. The apparatus of claim 3 further characterized in that said multiple representation is of a shift function; said shift function characterized in that when it is activated substantially simultaneously with a key of said ambiguous keyboard, selected symbols assigned to said key are input.

5. The apparatus of claim 3 further characterized in that said multiple representation is of a next function; and that said symbols are arranged in an order; said next function characterized in that it is effective to advance said symbols in said order.

6. An apparatus comprising a single row of keys; an ambiguous code; said ambiguous code characterized as being of minimized gesture distortion; where said gesture distortion is measured with respect to a conventional layout.

7. The apparatus of claim 6 where said gesture distortion is evaluated on a set of gestures; said gestures drawn from the set of said gestures comprising an interaction mechanism; said interaction mechanism selected from the set comprising two-thumb and eight-finger interaction mechanisms.

8. An apparatus comprising a keypad with one to nine columns; an ambiguous code; said ambiguous code characterized as being of minimized appearance distortion with respect to both order distortion and partition distortion; said order distortion and said partition distortion evaluated with respect to a conventional layout; said ambiguous code further characterized as maximized with respect to typability.

9. The apparatus of claim 8 further comprising a second ambiguous code, said second ambiguous code characterized as a hybrid chording-ambiguous code.

10. The apparatus of claim 8 further characterized in that said appearance distortion is of minimized description length.

11. A method for making typability optimized keyboards with reduced distortion comprising the steps of selecting a conventional keyboard layout; selecting a reduced spatial arrangement; selecting a distortion measure; selecting a typability measure, evaluating a set of layouts by measuring said distortion measure and said typability measure for each element of said set of layouts; selecting a subset of optimized layouts from said set of layouts.

12. An apparatus comprising an ambiguous keyboard; keys for inputting symbols; said keys arranged in a substantially linear array; disambiguation software; said ambiguous keyboard characterized as minimized with respect to gesture distortion.

13. An apparatus comprising an ambiguous keyboard; symbols; keys for inputting said symbols; disambiguation software; said ambiguous keyboard characterized as optimized with respect to at least one typability constraint; and minimized with respect to layout distortion, said layout distortion measured with respect to a conventional layout.

14. The apparatus of claim 13 characterized in that said symbols comprise digit and punctuation symbols, said apparatus further comprising an assignment of said digit and said punctuation symbols to least one of said keys, said assignment characterized in that at least one of each of said digit and said punctuation symbols are co-assigned to at least one of said keys, and further characterized in that at least one of morphic similarity and functional similarity between said co-assigned said digit and said punctuation symbols is optimized over a plurality of said keys.

15. The apparatus of claim 14 further comprising function symbols, said function symbols characterized as performing a function which modifies at least one of a functional characteristic and output of said disambiguation software.

16. The apparatus of claim 15 further comprising a link mechanism effective to link said function symbols into sequences.

17. The apparatus of claim 15 further characterized in that at least two of said function symbols are paired on the basis of at least one of said functional similarity and said morphic similarity, and further characterized in that said paired said function symbols are co-assigned to one of said keys.

18. The apparatus of claim 13 further comprising a selecting mechanism for selecting a subset of said symbols assigned to a given of said keys, said selection mechanism.

19. The apparatus of claim 18 further characterized in that selections made by said selecting mechanism are optimized to at least one of maximize said typability constraint and minimize said layout distortion.

20. The apparatus of claim 13 wherein said typability constraint is selected from the set consisting of lookup error, query error, effective key number, word-level ambiguity, word completion, phrase completion, drummoll probability, steric hindrance, throughput, robustness to typing error, number of sub-selected symbols, probability of a sub-selected symbol, language generality, Fitts' law, and keystrokes per character.

21. The apparatus of claim 20 where said drummoll probability is optimized with respect to a two-digit interaction mechanism.

22. The apparatus of claim 13 further characterized in that said typability constraint is optimized with respect to at least one interaction mechanism.

23. The apparatus of claim 22 further characterized in that said interaction mechanism is selected from the group consisting of one finger, one thumb, two fingers, two thumbs, one finger and one thumb, three fingers, and eight fingers and two thumbs.

24. The apparatus of claim 13 further characterized as compatible with a telephone keypad.

25. The apparatus of claim 13 further characterized in that said ambiguous keyboard comprises three rows and 1-9 columns.

26. The apparatus of claim 13 wherein said layout distortion is selected from the set consisting of appearance distortion and gesture distortion.

27. The apparatus of claim 26 wherein said gesture distortion is quantified by a gesture distortion property; said gesture distortion property selected from the set consisting of same hand, same digit, same finger, and same thumb, nearby digit, and same gesture class.

28. The apparatus of claim 26 wherein said appearance distortion is a function of at least one layout property; said layout property selected from the set consisting of order and partition structure.

29. The apparatus of claim 28 wherein distortions to said order are the same across a family of variable-layout keyboards.

30. The apparatus of claim 28 where distortions to said order are quantified by a distortion property; said distortion property selected from the set consisting of reading order, row-limited reading order, column-limited reading order, exterior, row-limited, column-limited, number, and number of exchanges.

31. The apparatus of claim 28 where said partition structure is quantified by a partition property; said partition property selected from the set consisting of even as possible, maximum number of letters on a key, minimum number of letters on a key, range, dominant class size, left-right symmetry, up-down symmetry, and monotonicity.

32. The apparatus of claim 26 wherein said appearance distortion is measured as a distortion relative to said conventional layout, and said conventional layout is selected from the set consisting of telephone keypad, qwerty, qwerty national variant, and unicode script conventions.

33. An unambiguous keyboard which is order distorted with respect to a conventional keyboard, said order distortion characterized in that it forms the basis of a family of typability optimized keyboards.
